(19) United States
(12) Patent Application Publication
(10) Pub. No.: US 2014/0216684 A1
(43) Pub. Date: Aug. 7, 2014

(54) HEATING, VENTILATING, AND AIR CONDITIONING SYSTEM WITH AN EXHAUST GAS THERMAL ENERGY EXCHANGER

(71) Applicant: VISTEON GLOBAL TECHNOLOGIES, INC., Van Buren Twp., MI (US)

(72) Inventor: Lakhi Nandlal Goenka, Ann Arbor, MI (US)

(73) Assignee: VISTEON GLOBAL TECHNOLOGIES, INC., Van Buren Twp., MI (US)

(21) Appl. No.: 13/756,696

(22) Filed: Feb. 1, 2013

(51) Int. Cl. B60H 1/00

(52) U.S. Cl. CPC B60H 1/00021
USPC 165/59

(57) ABSTRACT

A heating, ventilating, and air conditioning system for a vehicle has a control module including a housing having an air flow conduit formed therein. An evaporator core is disposed in the air flow conduit, wherein at least a portion of the evaporator is configured to receive a first fluid from a first fluid source therein. An internal thermal energy exchanger configured to receive a second fluid from a second fluid source is disposed in the air flow conduit downstream of at least a portion of the evaporator core and upstream of a blend door disposed in the air flow conduit. The internal thermal energy is in thermal energy exchange relationship with an exhaust gas system of the vehicle.

### FIELD OF THE INVENTION

The invention relates to a climate control system for a vehicle and more particularly to a heating, ventilating, and air conditioning system of a vehicle having an exhaust gas thermal energy exchanger.

### BACKGROUND OF THE INVENTION

A vehicle typically includes a climate control system which maintains a temperature within a passenger compartment of the vehicle at a comfortable level by providing heating, cooling, and ventilation. Comfort is maintained in the passenger compartment by an integrated mechanism referred to in the art as a heating, ventilating and air conditioning (HVAC) system. The HVAC system conditions air flowing therethrough and distributes the conditioned air throughout the passenger compartment.

Typically, a compressor of a refrigeration system provides a flow of a fluid having a desired temperature to an evaporator disposed in the HVAC system to condition the air. The compressor is generally driven by a fuel-powered engine of the vehicle. However, in recent years, vehicles having improved fuel economy over the fuel-powered engine and other vehicles are quickly becoming more popular as a cost of traditional fuel increases. The improved fuel economy is due to known technologies such as regenerative braking, electric motor assist, and engine-off operation. Although the technologies improve fuel economy, accessories powered by the fuel-powered engine no longer operate when the fuel-powered engine is not in operation. One major accessory that does not operate is the compressor of the refrigeration system. Therefore, without the use of the compressor, the evaporator disposed in the HVAC system does not condition the air flowing therethrough and the temperature of the passenger compartment increases to a point above a desired temperature.

Accordingly, vehicle manufacturers have used a thermal energy exchanger disposed in the HVAC system to condition the air flowing therethrough when the fuel-powered engine is not in operation. One such thermal energy exchanger, also referred to as a cold accumulator, is described in U.S. Pat. No. 6,854,513 entitled VEHICLE AIR CONDITIONING SYSTEM WITH COLD ACCUMULATOR, hereby incorporated herein by reference in its entirety. The cold accumulator includes a phase change material, also referred to as a cold accumulating material, disposed therein. The cold accumulating material absorbs heat from the air when the fuel-powered engine is not in operation. The cold accumulating material is then recharged by the conditioned air flowing from the cooling heat exchanger when the fuel-powered engine is in operation.

In U.S. Pat. No. 6,691,527 entitled AIR-CONDITIONER FOR A MOTOR VEHICLE, hereby incorporated herein by reference in its entirety, a thermal energy exchanger is disclosed having a phase change material disposed therein. The phase change material of the thermal energy exchanger conditions a flow of air through the HVAC system when the fuel-powered engine of the vehicle is not in operation. The phase change material is charged by a flow of a fluid from the refrigeration system therethrough.

While the prior art HVAC systems perform adequately, it is desirable to produce an HVAC system of a vehicle having an exhaust gas thermal energy exchanger, wherein an effectiveness and efficiency of the HVAC system are maximized.

### SUMMARY OF THE INVENTION

In concordance and agreement with the present invention, an HVAC system of a vehicle having an exhaust gas thermal energy exchanger, wherein an effectiveness and efficiency of the HVAC system are maximized, has surprisingly been discovered.

In one embodiment, a heating, ventilating, and air conditioning (HVAC) system of a vehicle, comprises: a control module including a housing having an air flow conduit formed therein; an evaporator core disposed in the air flow conduit, at least a portion of the evaporator core configured to receive a first fluid from a first fluid source therein; and a thermal energy exchanger disposed in the air flow conduit downstream of the at least a portion the evaporator core and upstream of a blend door disposed in the air flow conduit, wherein the thermal energy exchanger is in thermal energy exchange relationship with an exhaust gas system of the vehicle.

In another embodiment, a heating, ventilating, and air conditioning (HVAC) system of a vehicle, comprises: a control module including housing having an air flow conduit formed therein; an evaporator core disposed in the air flow conduit, at least a portion of the evaporator core configured to receive a first fluid from a first fluid source therein; a thermal energy exchanger disposed in the air flow conduit downstream of the at least a portion the evaporator core and upstream of a blend door disposed in the air flow conduit, the thermal energy exchanger configured to receive a second fluid from a second fluid source therein, wherein the first fluid and the second fluid are different fluid types; and a heater core disposed downstream of the thermal energy exchanger, wherein the heater core is configured to receive a third fluid from a third fluid source therein, wherein at least one of the thermal energy exchanger and the heater core is in thermal energy exchange relationship with an exhaust gas system of the vehicle.

In yet another embodiment, A heating, ventilating, and air conditioning (HVAC) system for a vehicle, comprises: a control module including housing having an air flow conduit formed therein; an evaporator core disposed in the air flow conduit, at least a portion of the evaporator core configured to receive a first fluid from a first fluid source therein; an internal thermal energy exchanger disposed in the air flow conduit downstream of the at least a portion the evaporator core and upstream of a blend door disposed in the air flow conduit, the thermal energy exchanger configured to receive a second fluid from a second fluid source therein, wherein the first fluid and the second fluid are different fluid types; a heater core disposed downstream of the thermal energy exchanger, wherein the heater core is configured to receive a third fluid from a third fluid source therein; and an external thermal energy exchanger in fluid communication with at least one of the internal thermal energy exchanger, the second fluid source, and a fourth fluid source, wherein the external thermal energy exchanger is in thermal energy exchange relationship with an exhaust gas system of the vehicle.

### BRIEF DESCRIPTION OF THE DRAWINGS

The above, as well as other objects and advantages of the invention, will become readily apparent to those skilled in the art from reading the following detailed description of various embodiments of the invention when considered in the light of the accompanying drawings in which:

FIG. 1 is a schematic flow diagram of an HVAC system including a fragmentary sectional view of an HVAC module having an evaporator core disposed therein according to an embodiment of the invention and showing the evaporator core in fluid communication with a first fluid source, an internal thermal energy exchanger in fluid communication with a second fluid source and in thermal energy exchange relationship with an exhaust gas system, and a heater core in fluid communication with a third fluid source;

FIG. 2 is a schematic perspective view of the evaporator core illustrated in FIG. 1 showing a portion of two layers of the evaporator core cutaway;

FIG. 3 is a schematic flow diagram of an HVAC system including a fragmentary sectional view of an HVAC module having an evaporator core disposed therein according to an embodiment of the invention and showing the evaporator core in fluid communication with a first fluid source, an internal thermal energy exchanger in fluid communication with a plurality of fluid sources and in thermal energy exchange relationship with an exhaust gas system;

FIG. 4 is a schematic flow diagram of an HVAC system including a fragmentary sectional view of an HVAC module having an evaporator core disposed therein according to an embodiment of the invention and showing the evaporator core in fluid communication with a first fluid source, an internal thermal energy exchanger in fluid communication with a second fluid source and a fourth fluid source, and a heater core in fluid communication with a third fluid source, wherein the internal thermal energy exchanger and the third fluid source are in thermal energy exchange relationship with an exhaust gas system;

FIG. 5 is a schematic flow diagram of an HVAC system including a fragmentary sectional view of an HVAC module having an evaporator core disposed therein according to an embodiment of the invention and showing the evaporator core in fluid communication with a first fluid source, an internal thermal energy exchanger in fluid communication with a second fluid source and a third fluid source, and a heater core in fluid communication with the third fluid source, wherein the second fluid source is in thermal energy exchange relationship with an exhaust gas system; and

FIG. 6 is a schematic flow diagram of an HVAC system including a fragmentary sectional view of an HVAC module having an evaporator core disposed therein according to an embodiment of the invention and showing the evaporator core in fluid communication with a first fluid source, an internal thermal energy exchanger in fluid communication with a second fluid source and a third fluid source, and a heater core in fluid communication with the third fluid source, wherein the second fluid source is in thermal energy exchange relationship with an exhaust gas system.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

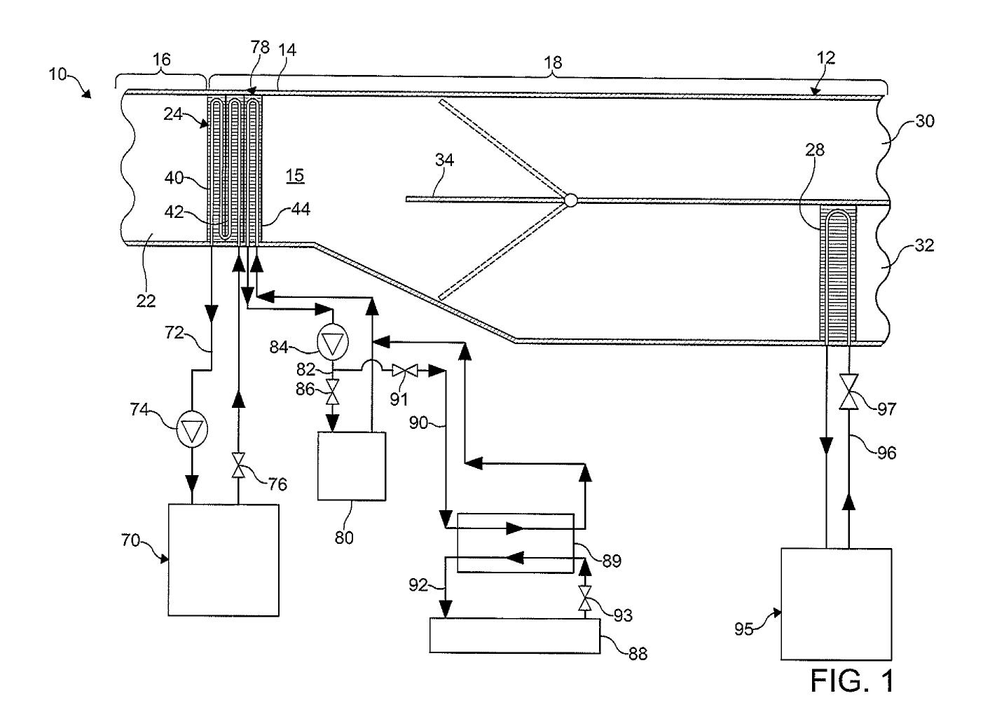

FIG. 1 shows a heating, ventilating, and air conditioning (HVAC) system 10 according to an embodiment of the invention. The HVAC system 10 typically provides heating, ventilation, and air conditioning for a passenger compartment of a vehicle (not shown). The HVAC system 10 includes a control module 12 to control at least a temperature of the passenger compartment.

The module 12 illustrated includes a hollow main housing 14 with an air flow conduit 15 formed therein. The housing 14 includes an inlet section 16, a mixing and conditioning section 18, and an outlet and distribution section (not shown). In the embodiment shown, an air inlet 22 is formed in the inlet section 16. The air inlet 22 is in fluid communication with a supply of air (not shown). The supply of air can be provided from outside of the vehicle, recirculated from the passenger compartment of the vehicle, or a mixture of the two, for example. The inlet section 16 is adapted to receive a blower wheel (not shown) therein to cause air to flow through the air inlet 22. A filter (not shown) can be provided upstream, in, or downstream of the inlet section 16 in respect of a direction of flow through the module 12 if desired.

The mixing and conditioning section 18 of the housing 14 is configured to receive an evaporator core 24 and a heater core 28 therein. As shown, at least a portion of the mixing and conditioning section 18 is divided into a first passage 30 and a second passage 32. In particular embodiments, the evaporator core 24 is disposed upstream of a selectively positionable blend door 34 in respect of the direction of flow through the module 12 and the heater core 28 is disposed in the second passage 32 downstream of the blend door 34 in respect of the direction of flow through the module 12. A filter (not shown) can also be provided upstream of the evaporator core 24 in respect of the direction of flow through the module 12, if desired.

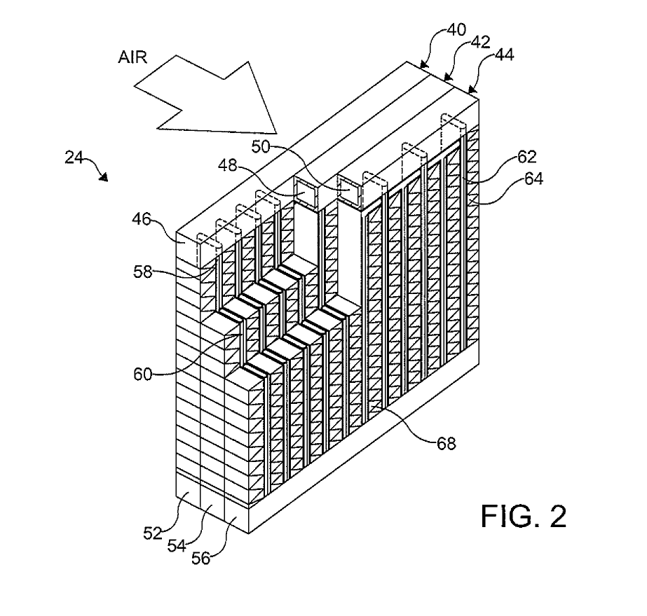

The evaporator core 24 of the present invention, shown in FIGS. 1-2, is a multi-layer louvered-fin thermal energy exchanger. In a non-limiting example, the evaporator core 24 has a first layer 40, a second layer 42, and a third layer 44 arranged substantially perpendicular to the direction of flow through the module 12. Additional or fewer layers than shown can be employed as desired. The layers 40, 42, 44 are arranged so the second layer 42 is disposed downstream of the first layer 40 and upstream of the third layer 44 in respect of the direction of flow through the module 12. It is understood, however, that the layers 40, 42, 44 can be arranged as desired. The layers 40, 42, 44 can be bonded together by any suitable method as desired such as brazing and welding, for example.

Each of the layers 40, 42, 44 of the evaporator core 24 includes an upper first fluid manifold 46, 48, 50 and a lower second fluid manifold 52, 54, 56, respectively. A plurality of first tubes 58 extends between the fluid manifolds 46, 52 of the first layer 40. A plurality of second tubes 60 extends between the fluid manifolds 48, 54 of the second layer 42. A plurality of third tubes 62 extends between the fluid manifolds 50, 56 of the third layer 44. In particular embodiments, each of the first upper fluid manifolds 46, 48, 50 is an inlet manifold which distributes the fluid into at least a portion of the respective tubes 58, 60, 62 and each of the second lower fluid manifolds 52, 54, 56 is an outlet manifold which collects the fluid from at least a portion of the respective tubes 58, 60, 62.

Each of the tubes 58, 60, 62 is provided with louvered fins 64 disposed therebetween. The fins 64 abut an outer surface of the tubes 58, 60, 62 for enhancing thermal energy transfer of the evaporate core 24. Each of the fins 64 defines an air space 68 extending between the tubes 58, 60, 62. The tubes 58, 60, 62 of the evaporator core 24 can further include a plurality of internal fins (not shown) formed on an inner surface thereof. The internal fins further enhance the transfer of thermal energy of the evaporator core 24. It is understood, however, that the evaporator core 24 can be constructed as a finless thermal energy exchanger if desired.

In a particular embodiment, the layers 40, 42 of the evaporator core 24, shown in FIG. 1, are in fluid communication with a first fluid source 70 via a conduit 72. The first fluid source 70 includes a prime mover 74 such as a compressor or a pump, for example, to cause a first fluid to circulate therein. Each of the layers 40, 42 is configured to receive a flow of the first fluid from the first fluid source 70 therein. The first fluid absorbs thermal energy to condition the air flowing through the HVAC module 12 when a fuel-powered engine of the vehicle, and thereby the prime mover 74, is in operation. As a non-limiting example, the first fluid source 70 is a refrigeration circuit, and the first fluid is a refrigerant such as R134a, HFO-1234yf, AC-5, AC-6, and CO₂, for example. A valve 76 can be disposed in the conduit 72 to selectively control the flow of the first fluid therethrough.

The HVAC system 10 includes an internal thermal energy exchanger 78 in fluid communication with a second fluid source 80 via a conduit 82. The second fluid source 80 includes a prime mover 84 (e.g. an electrical coolant pump) to cause a second fluid to circulate through the internal thermal energy exchanger 78. As illustrated, the internal thermal energy exchanger 78 is the layer 44 of the evaporator core 24. In other embodiments, the layers 40, 44 of the evaporator core 24 are in fluid communication with the first fluid source 70 and the internal thermal energy exchanger 78 is the layer 42 of the evaporator core 24 in thermal energy exchange relationship with the second fluid source 80. In yet other certain embodiments, only the layer 40 of the evaporator core 24 is in fluid communication with the first fluid source 70 and the internal thermal energy exchanger 78 is the layers 42, 44 of the evaporator core 24 in thermal energy exchange relationship with the second fluid source 80.

The internal thermal energy exchanger 78 is configured to receive a flow of the second fluid from the second fluid source 80 therein. The second fluid absorbs or releases thermal energy to condition the air flowing through the HVAC module 12. A valve 86 can be disposed in the conduit 82 to selectively control the flow of the second fluid therethrough. As a non-limiting example, the second fluid source 80 is a fluid reservoir containing a phase change material (PCM) therein. Those skilled in the art will appreciate that the phase change material can be any suitable material that melts and solidifies at predetermined temperatures and is capable of storing and releasing thermal energy such as organic, inorganic, eutectic and ionic liquids (e.g. a paraffin, a paraffin wax, an alcohol, water, a polygycol, a glycol), and the like, or any combination thereof, for example. The phase change material can also be impregnated with a thermally conductive material such as graphite powder, for example, to further enhance the transfer of thermal energy. As another non-limiting example, the second fluid source 80 is a fluid reservoir containing a coolant therein. As another non-limiting example, the second fluid source 80 is a fluid reservoir containing a phase change material coolant such as CryoSolplus, for example, therein. As yet another non-limiting example, the second fluid source 80 is an external thermal energy exchanger (e.g. a shell and tube heat exchanger, a chiller, etc.) which includes a phase change material disposed therein and/or is in fluid communication with at least one other vehicle system.

In certain embodiments, the internal thermal energy exchanger 78 is in thermal energy exchange relationship with an exhaust gas system 88 of the vehicle via an external thermal energy exchanger 89. Those skilled in the art will appreciate that the external thermal energy exchanger 89 can be any suitable thermal energy exchanger such as an exhaust gas recirculation (EGR) thermal energy exchanger, for example. As illustrated, the external thermal energy exchanger 89 is in fluid communication with the internal thermal energy exchanger 78 and configured to receive, through a conduit 90, a flow of a working fluid therein. A valve 91 can be disposed in the conduit 90 to selectively control the flow of the working fluid therethrough. The external thermal energy exchanger 89 is also in fluid communication with the exhaust gas system 88 and configured to receive, through a conduit 92, a flow of an exhaust gas therein. As shown, the flow of the exhaust gas through the external thermal energy exchanger 89 is counter to the flow of the working fluid therethrough. It is understood that the flow of the exhaust gas through the external thermal energy exchanger 89 can be in any suitable flow direction in respect of the flow of the working fluid as desired such as concurrent flow direction and a cross-flow direction, for example. A valve 93 can be disposed in the conduit 92 to selectively control the flow of the exhaust gas therethrough. The external thermal energy exchanger 89 facilitates a transfer of thermal energy from the exhaust gas to heat the working fluid, especially when the fuel-powered engine of the vehicle is in operation. The exhaust gas is typically at a temperature in a range of about 400° C. to about 1000° C. As such, the working fluid is heated very rapidly and may heat the air flowing through the air flow conduit 15 before the fuel-powered engine reaches a normal operating temperature. Accordingly, a size and capacity of the heater core 28 may be decreased in respect of heater cores of the prior art, which may facilitate a decrease in air side pressure drop during heating modes of the HVAC system 10, as well as an increase in available package space within the control module 12.

As shown, the heater core 28 is in fluid communication with a third fluid source 95 via a conduit 96. The heater core 28 is configured to receive a flow of a third fluid from the third fluid source 95 therein. The third fluid source 95 can be any conventional source of heated fluid such as the fuel-powered engine or a battery system of the vehicle, for example, and the third fluid can be any conventional fluid such as a phase change material, a coolant, or a phase change material coolant, for example. A valve 97 can be disposed in the conduit 96 to selectively control the flow of the third fluid therethrough. The heater core 28 is configured to facilitate a release of thermal energy from the third fluid to heat the air flowing therethrough when the fuel-powered engine of the vehicle is in operation. As a non-limiting example, the second fluid from the second fluid source 80, the working fluid from the external thermal energy exchanger 89, and the third fluid from the third fluid source 95 are the same fluid types. It is understood, however, that the second fluid from the second fluid source 80, the working fluid from the external thermal energy exchanger 89, and the third fluid from the third fluid source 95 may be different fluid types if desired.

In operation, the HVAC system 10 conditions air by heating or cooling the air, and providing the conditioned air to the passenger compartment of the vehicle. Air from the supply of air is received in the inlet section 16 of the housing 14 in the air inlet 22 and flows through the housing 14 of the module 12.

In each operating mode of the HVAC system 10, the blend door 34 may be positioned in one of a first position permitting air from the evaporator core 24 and the internal thermal energy exchange 78 to only flow into the first passage 30, a second position permitting the air from the evaporator core 24 and the internal thermal energy exchanger 78 to only flow into the second passage 32, and an intermediate position permitting the air from the evaporator core 24 and the internal thermal energy exchanger 78 to flow through both the first passage 30 and the second passage 32 and through the heater core 28

When the fuel-powered engine of the vehicle is in operation and the HVAC system 10 is operating in either a cooling mode or a cold thermal energy charge mode, the first fluid from the first fluid source 70 circulates through the conduit 72 to the evaporator core 24. Additionally, the second fluid from the second fluid source 80 circulates through the conduit 82 to the internal thermal energy exchanger 78. However, the valve 91 is closed to militate against the circulation of the working fluid from the external thermal energy exchanger 89 through the conduit 90 to the internal thermal energy exchanger 78, the valve 93 is closed to militate against the circulation of the exhaust gas from the exhaust gas system 88 through the conduit 92 to the external thermal energy exchanger 89, and the valve 97 is closed to militate against the circulation of the third fluid from the third fluid source 95 through the conduit 96 to the heater core 28. Accordingly, the air from the inlet section 16 flows into the evaporator core 24 where the air is cooled to a desired temperature by a transfer of thermal energy from the air to the first fluid from the first fluid source 70. The conditioned air then flows from the evaporator core 24 to the internal thermal energy exchanger 78. As the conditioned air flows through the internal thermal energy exchanger 78, the conditioned air absorbs thermal energy from the second fluid. The transfer of thermal energy from the second fluid to the conditioned air cools the second fluid. The second fluid then flows to the second fluid source 80 and absorbs thermal energy to cool or charge the phase change material, the coolant, the phase change material coolant, or any combination thereof contained in the second fluid source 80. The conditioned air then exits the internal thermal energy exchanger 78 and is selectively permitted by the blend door 34 to flow through the first passage 30 and/or the second passage 32. It is understood, however, that in other embodiments the valve 97 is open, permitting the third fluid from the third fluid source 95 to circulate through the conduit 96 to the heater core 28, and thereby demist the conditioned air flowing through the second passage 32.

In other certain embodiments, when the fuel-powered engine of the vehicle is in operation and the HVAC system 10 is operating in an alternative cooling mode, the first fluid from the first fluid source 70 circulates through the conduit 72 to the evaporator core 24. However, the valve 86 is closed to militate against the circulation of the second fluid from the second fluid source 80 through the conduit 82 to the internal thermal energy exchanger 78. Additionally, the valve 91 is closed to militate against the circulation of the working fluid from the external thermal energy exchanger 89 through the conduit 90 to the internal thermal energy exchanger 78, the valve 93 is closed to militate against the circulation of the exhaust gas from the exhaust gas system 88 through the conduit 92 to the external thermal energy exchanger 89, and the valve 97 is closed to militate against the circulation of the third fluid from the third fluid source 95 through the conduit 96 to the heater core 28. Accordingly, the air from the inlet section 16 flows into the evaporator core 24 where the air is cooled to a desired temperature by a transfer of thermal energy from the air to the first fluid from the first fluid source 70. The conditioned air then flows from the evaporator core 24 to the internal thermal energy exchanger 78. As the conditioned air flows through the internal thermal energy exchanger 78, the temperature of the conditioned air is relatively unaffected. The conditioned air then exits the internal thermal energy exchanger 78 and is selectively permitted by the blend door 34 to flow through the first passage 30 and/or the second passage 32. It is understood, however, that in other embodiments the valve 97 is open, permitting the third fluid from the third fluid source 95 to circulate through the conduit 96 to the heater core 28, and thereby demist the conditioned air flowing through the second passage 32.

When the fuel-powered engine of the vehicle is not in operation and the HVAC system 10 is operating in an engine-off cooling mode, the first fluid from the first fluid source 70 does not circulate through the conduit 72 to the evaporator core 24. Additionally, the valve 91 is closed to militate against the circulation of the working fluid from the external thermal energy exchanger 89 through the conduit 90 to the internal thermal energy exchanger 78, the exhaust gas from the exhaust gas system 88 does not circulate through the conduit 92 to the external thermal energy exchanger 89, and the third fluid from the third fluid source 95 does not circulate through the conduit 96 to the heater core 28. However, the second fluid from the second fluid source 80 circulates through the conduit 82 to the internal thermal energy exchanger 78. Accordingly, the air from the inlet section 16 flows through the evaporator core 24 where a temperature of the air is relatively unaffected. The air then flows from the evaporator core 24 to the internal thermal energy exchanger 78. As the air flows through the internal thermal energy exchanger 78, the air is cooled to a desired temperature by a transfer of thermal energy from the air to the second fluid from the second fluid source 80. The conditioned air then exits the thermal energy exchanger 78 and is selectively permitted by the blend door 34 to flow through the first passage 30 and/or the second passage 32.

When the fuel-powered engine of the vehicle is in operation and the HVAC system 10 is operating in a heating mode, the valve 76 is closed to militate against the circulation of the first fluid from the first fluid source 70 through the conduit 72 to the evaporator core 24. Similarly, the valve 86 is closed to militate against the circulation of the second fluid from the second fluid source 80 through the conduit 82 to the internal thermal energy exchanger 78. Additionally, the valve 91 is closed to militate against the circulation of the working fluid from the external thermal energy exchanger 89 through the conduit 90 to the internal thermal energy exchanger 78 and the valve 93 is closed to militate against the circulation of the exhaust gas from the exhaust gas system 88 through the conduit 92 to the external thermal energy exchanger 89. However, the third fluid from the third fluid source 95 circulates through the conduit 96 to the heater core 28. Accordingly, the air from the inlet section 16 flows through the evaporator core 24 and the internal thermal energy exchanger 78 where a temperature of the air is relatively unaffected. The unconditioned air then exits the evaporator core 24 and the internal thermal energy exchanger 78 and is selectively permitted by the blend door 34 to flow through the first passage 30 and/or the second passage 32 through the heater core 28 to be heated to a desired temperature.

In other certain embodiments, when the fuel-powered engine of the vehicle is in operation and the HVAC system 10 is operating in an alternative heating mode, the valve 76 is closed to militate against the circulation of the first fluid from the first fluid source 70 through the conduit 72 to the evaporator core 24. Similarly, the valve 86 is closed to militate against the circulation of the second fluid from the second fluid source 80 through the conduit 82 to the internal thermal energy exchanger 78. However, the working fluid from the external thermal energy exchanger 89 circulates through the conduit 90 to the internal thermal energy exchanger 78 and the exhaust gas from the exhaust gas system 88 circulates through the conduit 92 to the external thermal energy exchanger 89. Additionally, the valve 97 is closed to militate against the circulation of the third fluid from the third fluid source 95 through the conduit 96 to the heater core 28. Accordingly, the air from the inlet section 16 flows through the evaporator core 24 where a temperature of the air is relatively unaffected. The air then flows from the evaporator core 24 to the internal thermal energy exchanger 78. As the air flows through the internal thermal energy exchanger 78, the air is heated to a desired temperature by a transfer of thermal energy from the working fluid from the external thermal energy exchanger 89 to the air flowing through the internal thermal energy exchanger 78. The working fluid then flows to the external thermal energy exchanger 89. In the external thermal energy exchanger 89, the working fluid absorbs thermal energy from the exhaust gas to heat the working fluid. The conditioned air then exits the internal thermal energy exchanger 78 and is selectively permitted by the blend door 34 to flow through the first passage 30 and/or the second passage 32. It is understood, however, that in other embodiments the valve 97 is open, permitting the third fluid from the third fluid source 95 to circulate through the conduit 96 to the heater core 28, and thereby further heat the conditioned air flowing through the second passage 32 to a desired temperature.

When the fuel-powered engine of the vehicle is in operation and the HVAC system 10 is operating in another alternative heating mode, the valve 76 is closed to militate against the circulation of the first fluid from the first fluid source 70 through the conduit 72 to the evaporator core 24. Additionally, the valve 91 is closed to militate against the circulation of the working fluid from the external thermal energy exchanger 89 through the conduit 90 to the internal thermal energy exchanger 78, the valve 93 is closed to militate against the circulation of the exhaust gas from the exhaust gas system 88 through the conduit 92 to the external thermal energy exchanger 89, and the valve 97 is closed to militate against the circulation of the third fluid from the third fluid source 95 through the conduit 96 to the heater core 28. However, the second fluid from the second fluid source 80 circulates through the conduit 82 to the internal thermal energy exchanger 78. Accordingly, the air from the inlet section 16 flows through the evaporator core 24 where a temperature of the air is relatively unaffected. The unconditioned air then exits the evaporator core 24 and flows to the internal thermal energy exchanger 78. As the air flows through the internal thermal energy exchanger 78, the air is heated to a desired temperature by a transfer of thermal energy from the second fluid from the second fluid source 80 to the air flowing through the internal thermal energy exchanger 78. The conditioned air then exits the internal thermal energy exchanger 78 and is selectively permitted by the blend door 34 to flow through the first passage 30 and/or the second passage 32. It is understood, however, that in other embodiments the valve 97 is open, permitting the third fluid from the third fluid source 95 to circulate through the conduit 96 to the heater core 28, and thereby further heat the conditioned air flowing through the second passage 32 to a desired temperature.

In other certain embodiments, when the fuel-powered engine of the vehicle is in operation and the HVAC system 10 is operating in an alternative heating mode or a hot thermal energy charge mode, the valve 76 is closed to militate against the circulation of the first fluid from the first fluid source 70 through the conduit 72 to the evaporator core 24. Similarly, the valve 97 is closed to militate against the circulation of the third fluid from the third fluid source 95 through the conduit 96 to the heater core 28. However, the second fluid from the second fluid source 80 circulates through the conduit 82 to the internal thermal energy exchanger 78. Additionally, the working fluid from the external thermal energy exchanger 89 circulates through the conduit 90 to the internal thermal energy exchanger 78 and the exhaust gas from the exhaust gas system 88 circulates through the conduit 92 to the external thermal energy exchanger 89. The working fluid mixes with the second fluid before, in, or after flowing through the internal thermal energy exchanger 78. Accordingly, the air from the inlet section 16 flows through the evaporator core 24 where a temperature of the air is relatively unaffected. The air then flows from the evaporator core 24 to the internal thermal energy exchanger 78. As the air flows through the internal thermal energy exchanger 78, the air is heated to a desired temperature by a transfer of thermal energy from the mixture of the second fluid and the working fluid to the air flowing through the internal thermal energy exchanger 78. The mixture of the second fluid and the working fluid then flows to the second fluid source 80 and the external thermal energy exchanger 89. In the second fluid source 80, the mixture of the second fluid and the working fluid releases thermal energy to heat or charge the phase change material, the coolant, the phase change material coolant, or any combination thereof contained in the second fluid source 80. In the external thermal energy exchanger 89, the mixture of the second fluid and the working fluid absorbs thermal energy from the exhaust gas. The conditioned air then exits the internal thermal energy exchanger 78 and is selectively permitted by the blend door 34 to flow through the first passage 30 and/or the second passage 32. It is understood, however, that in other embodiments the valve 97 is open, permitting the third fluid from the third fluid source 95 to circulate through the conduit 96 to the heater core 28, and thereby further heat the conditioned air flowing through the second passage 32 to a desired temperature.

When the fuel-powered engine of the vehicle is not in operation and the HVAC system 10 is operating in an engine-off heating mode, the first fluid from the first fluid source 70 does not circulate through the conduit 72 to the evaporator core 24. Additionally, the valve 91 is closed to militate against the circulation of the working fluid from the external thermal energy exchanger 89 through the conduit 90 to the internal thermal energy exchanger 78, the exhaust gas from the exhaust gas system 88 does not circulate through the conduit 92 to the external thermal energy exchanger 89, and the third fluid from the third fluid source 95 does not circulate through the conduit 96 to the heater core 28. However, the second fluid from the second fluid source 80 circulates through the conduit 82 to the internal thermal energy exchanger 78. Accordingly, the air from the inlet section 16 flows through the evaporator core 24 where a temperature of the air is relatively unaffected. The air then flows from the evaporator core 24 to the internal thermal energy exchanger 78. As the air flows through the internal thermal energy exchanger 78, the air is heated to a desired temperature by a transfer of thermal energy from the second fluid from the second fluid source 80 to the air flowing through the internal thermal energy exchanger 78. The conditioned air then exits the thermal energy exchanger 78 and is selectively permitted by the blend door 34 to flow through the first passage 30 and/or the second passage 32.

When the fuel-powered engine of the vehicle is in operation and the HVAC system 10 is operating in a recirculation heating mode or an alternative hot thermal energy charge mode, the valve 76 is closed to militate against the circulation of the first fluid from the first fluid source 70 through the conduit 72 to the evaporator core 24. Similarly, the valve 86 is closed to militate against the circulation of the second fluid from the second fluid source 80 through the conduit 82 to the internal thermal energy exchanger 78. Additionally, the valve 91 is closed to militate against the circulation of the working fluid from the external thermal energy exchanger 89 through the conduit 90 to the internal thermal energy exchanger 78, the valve 93 is closed to militate against the circulation of the exhaust gas from the exhaust gas system 88 through the conduit 92 to the external thermal energy exchanger 89, and the valve 97 is closed to militate against the circulation of the third fluid from the third fluid source 95 through the conduit 96 to the heater core 28. Accordingly, a re-circulated air from a passenger compartment of the vehicle flows through the inlet section 16, through the evaporator core 24, and into the internal thermal energy exchanger 78 where a temperature of the air is relatively unaffected. The re-circulated air then exits the internal thermal energy exchanger 78 and is selectively permitted by the blend door 34 to flow through the first passage 30 and/or the second passage 32. It is understood, however, that in other embodiments the valve 86 is open permitting the second fluid from the second fluid source 80 which has been heated by the phase change material, the coolant, the phase change material coolant, or any combination thereof contained in the second fluid source 80 to circulate through the conduit 82 to the internal thermal energy exchanger 78, the valves 91, 93 are open permitting the working fluid from the external thermal energy exchanger 89 which has been heated by the exhaust gas to circulate through the conduit 90 to the internal thermal energy exchanger 78, and/or the valve 97 is open permitting the third fluid from the third fluid source 95 to circulate through the conduit 96 to the heater core 28, and thereby heat the re-circulated air flowing through the first passage 30 and/or the second passage 32. It is further understood that the valve 86 is open permitting the second fluid to absorb thermal energy from air flowing through the internal thermal energy exchanger 78, and thereby heat or charge the phase change material, the coolant, the phase change material coolant, or any combination thereof contained in the second fluid source 80.

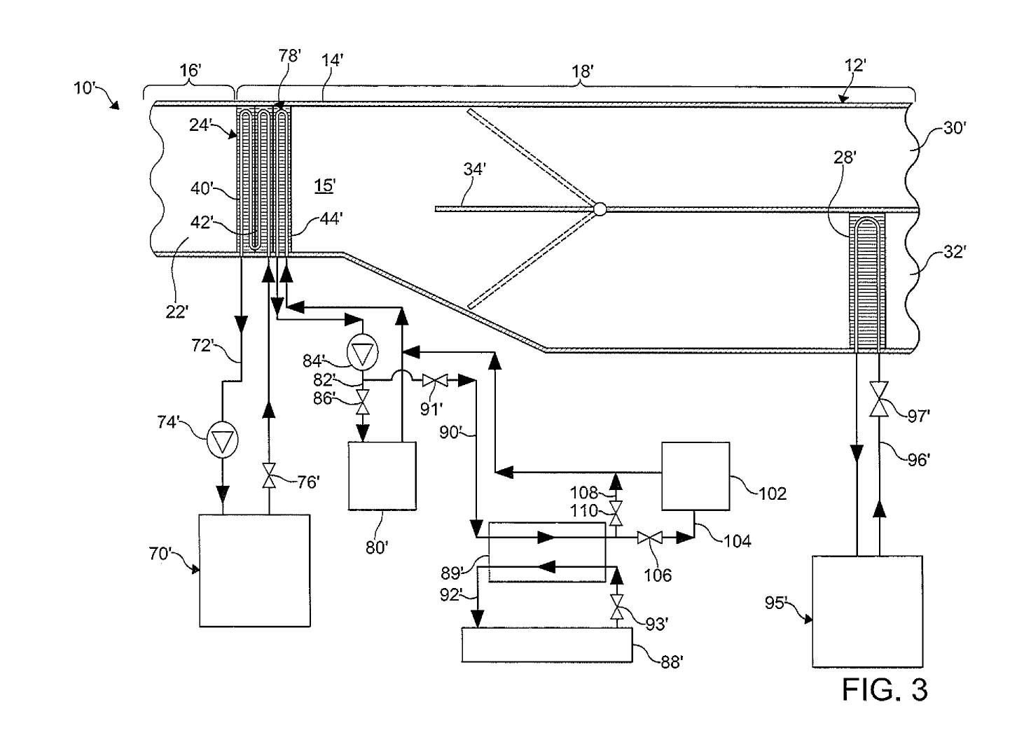

FIG. 3 shows an alternative embodiment of the HVAC system 10 illustrated in FIG. 1. Structure similar to that illustrated in FIGS. 1-2 includes the same reference numeral and a prime (′) symbol for clarity.

In FIG. 3, the HVAC system 10′ includes a control module 12′ to control at least a temperature of the passenger compartment. The module 12′ illustrated includes a hollow main housing 14′ with an air flow conduit 15′ formed therein. The housing 14′ includes an inlet section 16′, a mixing and conditioning section 18′, and an outlet and distribution section (not shown). In the embodiment shown, an air inlet 22′ is formed in the inlet section 16′. The air inlet 22′ is in fluid communication with a supply of air (not shown). The supply of air can be provided from outside of the vehicle, recirculated from the passenger compartment of the vehicle, or a mixture of the two, for example. The inlet section 16′ is adapted to receive a blower wheel (not shown) therein to cause air to flow through the air inlet 22′. A filter (not shown) can be provided upstream, in, or downstream of the inlet section 16′ in respect of a direction of flow through the module 12′ if desired.

The mixing and conditioning section 18′ of the housing 14′ is configured to receive an evaporator core 24′ and a heater core 28′ therein. As shown, at least a portion of the mixing and conditioning section 18′ is divided into a first passage 30′ and a second passage 32′. In particular embodiments, the evaporator core 24′ is disposed upstream of a selectively positionable blend door 34′ in respect of the direction of flow through the module 12′ and the heater core 28′ is disposed in the second passage 32′ downstream of the blend door 34′ in respect of the direction of flow through the module 12′. A filter (not shown) can also be provided upstream of the evaporator core 24′ in respect of the direction of flow through the module 12′, if desired.

The evaporator core 24′ of the present invention is a multi-layer louvered-fin thermal energy exchanger. In a non-limiting example, the evaporator core 24′ has a first layer 40′, a second layer 42′, and a third layer 44′ arranged substantially perpendicular to the direction of flow through the module 12′. Additional or fewer layers than shown can be employed as desired. The layers 40′, 42′, 44′ are arranged so the second layer 42′ is disposed downstream of the first layer 40′ and upstream of the third layer 44′ in respect of the direction of flow through the module 12′. It is understood, however, that the layers 40′, 42′, 44′ can be arranged as desired. The layers 40′, 42′, 44′ can be bonded together by any suitable method as desired such as brazing and welding, for example.

In a particular embodiment, the layers 40′, 42′ of the evaporator core 24′, shown in FIG. 3, are in fluid communication with a first fluid source 70′ via a conduit 72′. The first fluid source 70′ includes a prime mover 74′ such as a compressor or a pump, for example, to cause a first fluid to circulate therein. Each of the layers 40′, 42′ is configured to receive a flow of the first fluid from the first fluid source 70′ therein. The first fluid absorbs thermal energy to condition the air flowing through the HVAC module 12′ when a fuel-powered engine of the vehicle, and thereby the prime mover 74′, is in operation. As a non-limiting example, the first fluid source 70′ is a refrigeration circuit, and the first fluid is a refrigerant such as R134a, HFO-1234yf, AC-5, AC-6, and CO₂, for example. A valve 76′ can be disposed in the conduit 72′ to selectively control the flow of the first fluid therethrough.

The HVAC system 10′ includes an internal thermal energy exchanger 78′ in fluid communication with a second fluid source 80′ via a conduit 82′. The second fluid source 80′ includes a prime mover 84′ (e.g. an electrical coolant pump) to cause a second fluid to circulate through the internal thermal energy exchanger 78′. As illustrated, the internal thermal energy exchanger 78′ is the layer 44′ of the evaporator core 24′. In other embodiments, the layers 40′, 44′ of the evaporator core 24′ are in fluid communication with the first fluid source 70′ and the internal thermal energy exchanger 78′ is the layer 42′ of the evaporator core 24′ in thermal energy exchange relationship with the second fluid source 80′. In yet other certain embodiments, only the layer 40′ of the evaporator core 24′ is in fluid communication with the first fluid source 70′ and the internal thermal energy exchanger 78′ is the layers 42′, 44′ of the evaporator core 24′ in thermal energy exchange relationship with the second fluid source 80′.

The internal thermal energy exchanger 78′ is configured to receive a flow of the second fluid from the second fluid source 80′ therein. The second fluid absorbs or releases thermal energy to condition the air flowing through the HVAC module 12′. A valve 86′ can be disposed in the conduit 82′ to selectively control the flow of the second fluid therethrough. As a non-limiting example, the second fluid source 80′ is a fluid reservoir containing a phase change material (PCM) therein. Those skilled in the art will appreciate that the phase change material can be any suitable material that melts and solidifies at predetermined temperatures and is capable of storing and releasing thermal energy such as organic, inorganic, eutectic and ionic liquids (e.g. a paraffin, a paraffin wax, an alcohol, water, a polygycol, a glycol), and the like, or any combination thereof, for example. The phase change material can also be impregnated with a thermally conductive material such as graphite powder, for example, to further enhance the transfer of thermal energy. As another non-limiting example, the second fluid source 80′ is a fluid reservoir containing a coolant therein. As another non-limiting example, the second fluid source 80′ is a fluid reservoir containing a phase change material coolant such as CryoSolplus, for example, therein. As yet another non-limiting example, the second fluid source 80′ is an external thermal energy exchanger (e.g. a shell and tube heat exchanger, a chiller, etc.) which includes a phase change material disposed therein and/or is in fluid communication with at least one other vehicle system.

In certain embodiments, the internal thermal energy exchanger 78′ is in thermal energy exchange relationship with an exhaust gas system 88′ of the vehicle via an external thermal energy exchanger 89′. Those skilled in the art will appreciate that the external thermal energy exchanger 89′ can be any suitable thermal energy exchanger such as an exhaust gas recirculation (EGR) thermal energy exchanger, for example. As illustrated, the external thermal energy exchanger 89′ is in fluid communication with the internal thermal energy exchanger 78′ and configured to receive, through a conduit 90′, a flow of the working fluid therein. A valve 91′ can be disposed in the conduit 90′ to selectively control the flow of the working fluid therethrough. The external thermal energy exchanger 89′ is also in fluid communication with the exhaust gas system 88′ and configured to receive, through a conduit 92′, a flow of an exhaust gas therein. As shown, the flow of the exhaust gas through the external thermal energy exchanger 89′ is counter to the flow of the working fluid therethrough. It is understood that the flow of the exhaust gas through the external thermal energy exchanger 89′ can be in any suitable flow direction in respect of the flow of the working fluid as desired such as a concurrent flow direction and a cross-flow direction, for example. A valve 93′ can be disposed in the conduit 92′ to selectively control the flow of the exhaust gas therethrough. The external thermal energy exchanger 89′ facilitates a transfer of thermal energy from the exhaust gas to heat the working fluid, especially when the fuel-powered engine of the vehicle is in operation. The exhaust gas is typically at a temperature in a range of about 400° C. to about 1000° C. As such, the working fluid is heated very rapidly and may heat the air flowing through the air flow conduit 15′ before the fuel-powered engine reaches a normal operating temperature. Accordingly, a size and capacity of the heater core 28′ may be decreased in respect of heater cores of the prior art, which may facilitate a decrease in air side pressure drop during heating modes of the HVAC system 10′, as well as an increase in available package space within the control module 12′.

As shown, the heater core 28′ is in fluid communication with a third fluid source 95′ via a conduit 96′. The heater core 28′ is configured to receive a flow of a third fluid from the third fluid source 95′ therein. The third fluid source 95′ can be any conventional source of heated fluid such as the fuel-powered engine or a battery system of the vehicle, for example, and the third fluid can be any conventional fluid such as a phase change material, a coolant, or a phase change material coolant, for example. A valve 97′ can be disposed in the conduit 96′ to selectively control the flow of the third fluid therethrough. The heater core 28′ is configured to facilitate a release of thermal energy from the third fluid to heat the air flowing therethrough when the fuel-powered engine of the vehicle is in operation.

A fourth fluid source 102 is in fluid communication with the external thermal energy exchanger 89′ via a conduit 104. The fourth fluid source 102 is configured to receive a flow of a fourth fluid therein. In certain embodiments, the fourth fluid is the working fluid from the external thermal energy exchanger 89′. A valve 106 can be disposed in the conduit 104 to selectively control the flow of the fourth fluid therethrough. As a non-limiting example, the fourth fluid source 102 is a fluid reservoir containing a phase change material (PCM) therein. Those skilled in the art will appreciate that the phase change material can be any suitable material that melts and solidifies at predetermined temperatures and is capable of storing and releasing thermal energy such as organic, inorganic, eutectic and ionic liquids (e.g. a paraffin, a paraffin wax, an alcohol, water, a polygycol, a glycol), and the like, or any combination thereof, for example. The phase change material can also be impregnated with a thermally conductive material such as graphite powder, for example, to further enhance the transfer of thermal energy. As another non-limiting example, the fourth fluid source 102 is a fluid reservoir containing a coolant therein. As another non-limiting example, the fourth fluid source 102 is a fluid reservoir containing a phase change material coolant such as CryoSolplus, for example, therein. As yet another non-limiting example, the fourth fluid source 102 is an external thermal energy exchanger (e.g. a shell and tube heat exchanger, a chiller, etc.) which includes a phase change material disposed therein and/or is in fluid communication with at least one other vehicle system.

The external thermal energy exchanger 89′ is also in fluid communication with the internal thermal energy exchanger 78′ via a bypass conduit 108. A valve 110 can be disposed in the bypass conduit 108 to selectively control the flow of the fourth fluid therethrough. As a non-limiting example, the second fluid from the second fluid source 80′, the working fluid from the external thermal energy exchanger 89′, the third fluid from the third fluid source 95′, and the fourth fluid from the fourth fluid source 102 are the same fluid types. It is understood, however, that the second fluid from the second fluid source 80′, the working fluid from the external thermal energy exchanger 89′, the third fluid from the third fluid source 95′, and the fourth fluid from the fourth fluid source 102 may be different fluid types if desired.

In operation, the HVAC system 10′ conditions air by heating or cooling the air, and providing the conditioned air to the passenger compartment of the vehicle. Air from the supply of air is received in the inlet section 16′ of the housing 14′ in the air inlet 22′ and flows through the housing 14′ of the module 12′.

In each operating mode of the HVAC system 10′, the blend door 34′ may be positioned in one of a first position permitting air from the evaporator core 24′ and the internal thermal energy exchange 78′ to only flow into the first passage 30′, a second position permitting the air from the evaporator core 24′ and the internal thermal energy exchanger 78′ to only flow into the second passage 32′, and an intermediate position permitting the air from the evaporator core 24′ and the internal thermal energy exchanger 78′ to flow through both the first passage 30′ and the second passage 32′ and through the heater core 28′

When the fuel-powered engine of the vehicle is in operation and the HVAC system 10′ is operating in either a cooling mode or a cold thermal energy charge mode, the first fluid from the first fluid source 70′ circulates through the conduit 72′ to the evaporator core 24′. Additionally, the second fluid from the second fluid source 80′ circulates through the conduit 82′ to the internal thermal energy exchanger 78′. However, the valves 91′, 106, 110 are closed to militate against the circulation of the fourth fluid from the external thermal energy exchanger 89′ and the fourth fluid source 102 through the respective conduits 90′, 104, 108 to the internal thermal energy exchanger 78′, the valve 93′ is closed to militate against the circulation of the exhaust gas from the exhaust gas system 88′ through the conduit 92′ to the external thermal energy exchanger 89′, and the valve 97′ is closed to militate against the circulation of the third fluid from the third fluid source 95′ through the conduit 96′ to the heater core 28′. Accordingly, the air from the inlet section 16′ flows into the evaporator core 24′ where the air is cooled to a desired temperature by a transfer of thermal energy from the air to the first fluid from the first fluid source 70′. The conditioned air then flows from the evaporator core 24′ to the internal thermal energy exchanger 78′. As the conditioned air flows through the internal thermal energy exchanger 78′, the conditioned air absorbs thermal energy from the second fluid. The transfer of thermal energy from the second fluid to the conditioned air cools the second fluid. The second fluid then flows to the second fluid source 80′ and absorbs thermal energy to cool or charge the phase change material, the coolant, the phase change material coolant, or any combination thereof contained in the second fluid source 80′. The conditioned air then exits the internal thermal energy exchanger 78′ and is selectively permitted by the blend door 34′ to flow through the first passage 30′ and/or the second passage 32′. It is understood, however, that in other embodiments the valve 97′ is open, permitting the third fluid from the third fluid source 95′ to circulate through the conduit 96′ to the heater core 28′, and thereby demist the conditioned air flowing through the second passage 32′.

In other certain embodiments, when the fuel-powered engine of the vehicle is in operation and the HVAC system 10′ is operating in an alternative cooling mode, the first fluid from the first fluid source 70′ circulates through the conduit 72′ to the evaporator core 24′. However, the valve 86′ is closed to militate against the circulation of the second fluid from the second fluid source 80′ through the conduit 82′ to the internal thermal energy exchanger 78′. Additionally, the valves 91′, 106, 110 are closed to militate against the circulation of the fourth fluid from the external thermal energy exchanger 89′ and the fourth fluid source 102 through the respective conduits 90′, 104, 108 to the internal thermal energy exchanger 78′, the valve 93′ is closed to militate against the circulation of the exhaust gas from the exhaust gas system 88′ through the conduit 92′ to the external thermal energy exchanger 89′, and the valve 97′ is closed to militate against the circulation of the third fluid from the third fluid source 95′ through the conduit 96′ to the heater core 28′. Accordingly, the air from the inlet section 16′ flows into the evaporator core 24′ where the air is cooled to a desired temperature by a transfer of thermal energy from the air to the first fluid from the first fluid source 70′. The conditioned air then flows from the evaporator core 24′ to the internal thermal energy exchanger 78′. As the conditioned air flows through the internal thermal energy exchanger 78′, the temperature of the conditioned air is relatively unaffected. The conditioned air then exits the internal thermal energy exchanger 78′ and is selectively permitted by the blend door 34′ to flow through the first passage 30′ and/or the second passage 32′. It is understood, however, that in other embodiments the valve 97′ is open, permitting the third fluid from the third fluid source 95′ to circulate through the conduit 96′ to the heater core 28′, and thereby demist the conditioned air flowing through the second passage 32′.

When the fuel-powered engine of the vehicle is not in operation and the HVAC system 10′ is operating in an engine-off cooling mode, the first fluid from the first fluid source 70′ does not circulate through the conduit 72′ to the evaporator core 24′. Additionally, the valves 91′, 106, 110 are closed to militate against the circulation of the fourth fluid from the external thermal energy exchanger 89′ and the fourth fluid source 102 through the respective conduits 90′, 104, 108 to the internal thermal energy exchanger 78′, the exhaust gas from the exhaust gas system 88′ does not circulate through the conduit 92′ to the external thermal energy exchanger 89′, and the third fluid from the third fluid source 95′ does not circulate through the conduit 96′ to the heater core 28′. However, the second fluid from the second fluid source 80′ circulates through the conduit 82′ to the internal thermal energy exchanger 78′. Accordingly, the air from the inlet section 16′ flows through the evaporator core 24′ where a temperature of the air is relatively unaffected. The air then flows from the evaporator core 24′ to the internal thermal energy exchanger 78′. As the air flows through the internal thermal energy exchanger 78′, the air is cooled to a desired temperature by a transfer of thermal energy from the air to the second fluid from the second fluid source 80′. The conditioned air then exits the thermal energy exchanger 78′ and is selectively permitted by the blend door 34′ to flow through the first passage 30′ and/or the second passage 32′.

When the fuel-powered engine of the vehicle is in operation and the HVAC system 10′ is operating in a heating mode, the valve 76′ is closed to militate against the circulation of the first fluid from the first fluid source 70′ through the conduit 72′ to the evaporator core 24′. Similarly, the valve 86′ is closed to militate against the circulation of the second fluid from the second fluid source 80′ through the conduit 82′ to the internal thermal energy exchanger 78′. Additionally, the valves 91′, 106, 110 are closed to militate against the circulation of the fourth fluid from the external thermal energy exchanger 89′ and the fourth fluid source 102 through the respective conduits 90′, 104, 108 to the internal thermal energy exchanger 78′ and the valve 93′ is closed to militate against the circulation of the exhaust gas from the exhaust gas system 88′ through the conduit 92′ to the external thermal energy exchanger 89′. However, the third fluid from the third fluid source 95′ circulates through the conduit 96′ to the heater core 28′. Accordingly, the air from the inlet section 16′ flows through the evaporator core 24′ and the internal thermal energy exchanger 78′ where a temperature of the air is relatively unaffected. The unconditioned air then exits the evaporator core 24′ and the internal thermal energy exchanger 78′ and is selectively permitted by the blend door 34′ to flow through the first passage 30′ and/or the second passage 32′ through the heater core 28′ to be heated to a desired temperature.

In other certain embodiments, when the fuel-powered engine of the vehicle is in operation and the HVAC system 10′ is operating in an alternative heating mode, the valve 76′ is closed to militate against the circulation of the first fluid from the first fluid source 70′ through the conduit 72′ to the evaporator core 24′. Similarly, the valve 86′ is closed to militate against the circulation of the second fluid from the second fluid source 80′ through the conduit 82′ to the internal thermal energy exchanger 78′, the valve 106 is closed to militate against the circulation of the fourth fluid from the external thermal energy exchanger 89′ to the fourth fluid source 102, and the valve 97′ is closed to militate against the circulation of the third fluid from the third fluid source 95′ through the conduit 96′ to the heater core 28′. However, the fourth fluid from the external thermal energy exchanger 89′ circulates through the conduits 91′, 108 to the internal thermal energy exchanger 78′ and the exhaust gas from the exhaust gas system 88′ circulates through the conduit 92′ to the external thermal energy exchanger 89′. Accordingly, the air from the inlet section 16′ flows through the evaporator core 24′ where a temperature of the air is relatively unaffected. The air then flows from the evaporator core 24′ to the internal thermal energy exchanger 78′. As the air flows through the internal thermal energy exchanger 78′, the air is heated to a desired temperature by a transfer of thermal energy from the fourth fluid from the external thermal energy exchanger 89′ to the air flowing through the internal thermal energy exchanger 78′. In the external thermal energy exchanger 89′, the fourth fluid absorbs thermal energy from the exhaust gas to heat the second fluid. The conditioned air then exits the internal thermal energy exchanger 78′ and is selectively permitted by the blend door 34′ to flow through the first passage 30′ and/or the second passage 32′. It is understood, however, that in other embodiments the valve 97′ is open, permitting the third fluid from the third fluid source 95′ to circulate through the conduit 96′ to the heater core 28′, and thereby further heat the conditioned air flowing through the second passage 32′ to a desired temperature.

When the fuel-powered engine of the vehicle is in operation and the HVAC system 10′ is operating in another alternative heating mode, the valve 76′ is closed to militate against the circulation of the first fluid from the first fluid source 70′ through the conduit 72′ to the evaporator core 24′. Additionally, the valve 86′ is closed to militate against the circulation of the second fluid from the second fluid source 80′ through the conduit 82′ to the internal thermal energy exchanger 78′, the valve 93′ is closed to militate against the circulation of the exhaust gas from the exhaust gas system 88′ through the conduit 92′ to the external thermal energy exchanger 89′, the valve 97′ is closed to militate against the circulation of the third fluid from the third fluid source 95′ through the conduit 96′ to the heater core 28′, and the valve 110 is closed to militate against the circulation of the fourth fluid from the external thermal energy exchanger 89′ through the bypass conduit 110. However, the fourth fluid from the fourth fluid source 102 circulates through the conduit 90′, through the inoperative external thermal energy exchanger 89′, and through the conduit 104 to the internal thermal energy exchanger 78′. Accordingly, the air from the inlet section 16′ flows through the evaporator core 24′ where a temperature of the air is relatively unaffected. The unconditioned air then exits the evaporator core 24′ and flows to the internal thermal energy exchanger 78′. As the air flows through the internal thermal energy exchanger 78′, the air is heated to a desired temperature by a transfer of thermal energy from the fourth fluid from the fourth fluid source 102 to the air flowing through the internal thermal energy exchanger 78′. The conditioned air then exits the internal thermal energy exchanger 78′ and is selectively permitted by the blend door 34′ to flow through the first passage 30′ and/or the second passage 32′. It is understood, however, that in other embodiments the valve 93 is open permitting the circulation of the exhaust gas from the exhaust gas system 88′ through the conduit 92′ to the external thermal energy exchanger 89′ to transfer thermal energy to the fourth fluid from the fourth fluid source 102 and/or the valve 97′ is open, permitting the third fluid from the third fluid source 95′ to circulate through the conduit 96′ to the heater core 28′, and thereby further heat the conditioned air flowing through the second passage 32′ to a desired temperature.

In other certain embodiments, when the fuel-powered engine of the vehicle is in operation and the HVAC system 10′ is operating in another alternative heating mode or a hot thermal energy charge mode, the valve 76′ is closed to militate against the circulation of the first fluid from the first fluid source 70′ through the conduit 72′ to the evaporator core 24′. Similarly, the valve 86′ is closed to militate against the circulation of the second fluid from the second fluid source 80′ through the conduit 82′ to the internal thermal energy exchanger 78′, the valve 110 is closed to militate against the circulation of the fourth fluid from the external thermal energy exchanger 89′ through the bypass conduit 110, and the valve 97′ is closed to militate against the circulation of the third fluid from the third fluid source 95′ through the conduit 96′ to the heater core 28′. However, the fourth fluid from the fourth fluid source 102 circulates through the conduit 90′, through the external thermal energy exchanger 89′, and through the conduit 104 to the internal thermal energy exchanger 78′. The exhaust gas from the exhaust gas system 88′ circulates through the conduit 92′ to the external thermal energy exchanger 89′. In the fourth fluid source 102, the fourth fluid, which has been heated by the exhaust gas, transfers thermal energy to heat or charge the phase change material, the coolant, the phase change material coolant, or any combination thereof contained in the fourth fluid source 102. Accordingly, the air from the inlet section 16′ flows through the evaporator core 24′ where a temperature of the air is relatively unaffected. The air then flows from the evaporator core 24′ to the internal thermal energy exchanger 78′. As the air flows through the internal thermal energy exchanger 78′, the air is heated to a desired temperature by a transfer of thermal energy from the fourth fluid to the air flowing through the internal thermal energy exchanger 78′. The conditioned air then exits the internal thermal energy exchanger 78′ and is selectively permitted by the blend door 34′ to flow through the first passage 30′ and/or the second passage 32′. It is understood, however, that in other embodiments the valve 97′ is open, permitting the third fluid from the third fluid source 95′ to circulate through the conduit 96′ to the heater core 28′, and thereby further heat the conditioned air flowing through the second passage 32′ to a desired temperature

When the fuel-powered engine of the vehicle is not in operation and the HVAC system 10′ is operating in an engine-off heating mode, the first fluid from the first fluid source 70′ does not circulate through the conduit 72′ to the evaporator core 24′. Similarly, the valve 86′ is closed to militate against the circulation of the second fluid from the second fluid source 80′ through the conduit 82′ to the internal thermal energy exchanger 78′ and the valve 110 is closed to militate against the circulation of the fourth fluid from the external thermal energy exchanger 89′ through the bypass conduit 108 to the internal thermal energy exchanger 78′. Additionally, the exhaust gas from the exhaust gas system 88′ does not circulate through the conduit 92′ to the external thermal energy exchanger 89′ and the third fluid from the third fluid source 95′ does not circulate through the conduit 96′ to the heater core 28′. However, the fourth fluid from the fourth fluid source 102 circulates through the conduit 90′, through the inoperative external thermal energy exchanger 89′, and through the conduit 104 to the internal thermal energy exchanger 78′. Accordingly, the air from the inlet section 16′ flows through the evaporator core 24′ where a temperature of the air is relatively unaffected. The air then flows from the evaporator core 24′ to the internal thermal energy exchanger 78′. As the air flows through the internal thermal energy exchanger 78′, the air is heated to a desired temperature by a transfer of thermal energy from the fourth fluid from the fourth fluid source 102 to the air flowing through the internal thermal energy exchanger 78′. The conditioned air then exits the thermal energy exchanger 78′ and is selectively permitted by the blend door 34′ to flow through the first passage 30′ and/or the second passage 32′.

When the fuel-powered engine of the vehicle is in operation and the HVAC system 10′ is operating in a recirculation heating mode or an alternative hot thermal energy charge mode, the valve 76′ is closed to militate against the circulation of the first fluid from the first fluid source 70′ through the conduit 72′ to the evaporator core 24′. Similarly, the valve 86′ is closed to militate against the circulation of the second fluid from the second fluid source 80′ through the conduit 82′ to the internal thermal energy exchanger 78′. Additionally, the valves 91′, 106, 110 are closed to militate against the circulation of the fourth fluid to the internal thermal energy exchanger 78′, the valve 93′ is closed to militate against the circulation of the exhaust gas from the exhaust gas system 88′ through the conduit 92′ to the external thermal energy exchanger 89′, and the valve 97′ is closed to militate against the circulation of the third fluid from the third fluid source 95′ through the conduit 96′ to the heater core 28′. Accordingly, a re-circulated air from a passenger compartment of the vehicle flows through the inlet section 16′, through the evaporator core 24′, and into the internal thermal energy exchanger 78′ where a temperature of the air is relatively unaffected. The re-circulated air then exits the internal thermal energy exchanger 78′ and is selectively permitted by the blend door 34 to flow through the first passage 30′ and/or the second passage 32′. It is understood, however, that in other embodiments the valves 91′, 110, 93′ are open permitting the fourth fluid from the external thermal energy exchanger 89′ heated by the exhaust gas to circulate through the conduits 91′, 108 to the internal thermal energy exchanger 78′, the valves 91′, 106 are open permitting the fourth fluid from the fourth fluid source 102 heated by the phase change material, the coolant, the phase change material coolant, or any combination thereof contained in the fourth fluid source 102 to circulate through the conduits 91′, 104 to the internal thermal energy exchanger 78′, the valves 91′, 106, 93′ are open permitting the fourth fluid from the fourth fluid source 102 heated by the exhaust gas and the phase change material, the coolant, the phase change material coolant, or any combination thereof contained in the fourth fluid source 102 to circulate through the conduits 91′, 104 to the internal thermal energy exchanger 78′, and/or the valve 97′ is open permitting the third fluid from the third fluid source 95′ to circulate through the conduit 96′ to the heater core 28′, and thereby heat the re-circulated air flowing through the first passage 30′ and/or the second passage 32′. It is further understood that the valves 91′, 106 are open permitting the fourth fluid to absorb thermal energy from air flowing through the internal thermal energy exchanger 78′, and thereby heat or charge the phase change material, the coolant, the phase change material coolant, or any combination thereof contained in the fourth fluid source 102.

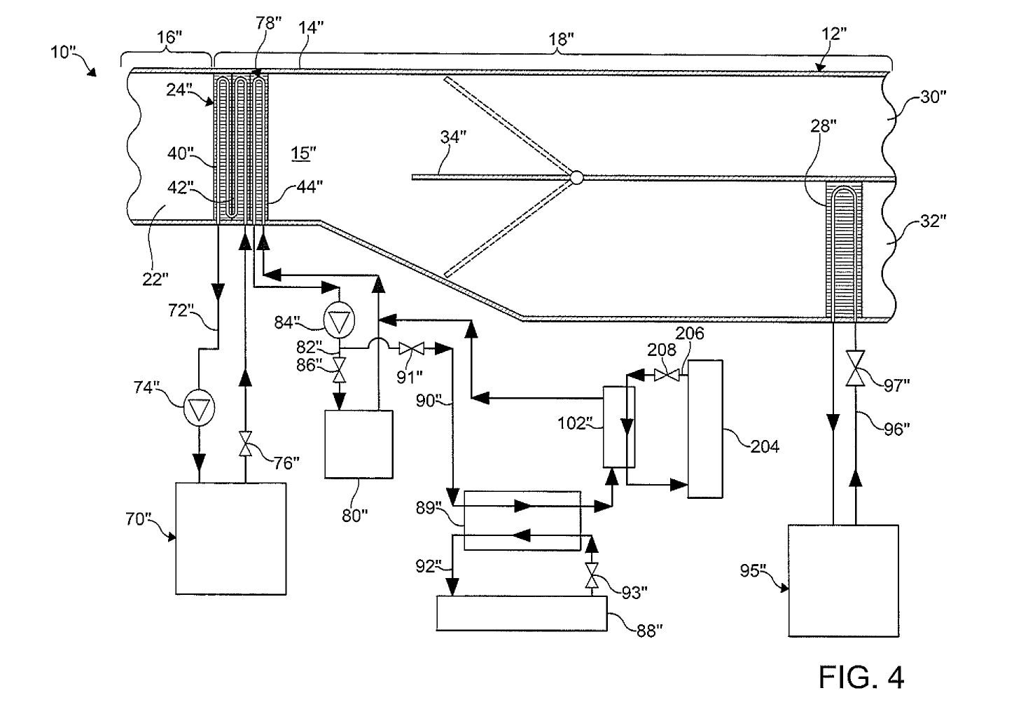

FIG. 4 shows an alternative embodiment of the HVAC systems 10, 10′ illustrated in FIGS. 1 and 3. Structure similar to that illustrated in FIGS. 1-3 includes the same reference numeral and a double prime (″) symbol for clarity.

In FIG. 4, the HVAC system 10″ includes a control module 12″ to control at least a temperature of the passenger compartment. The module 12″ illustrated includes a hollow main housing 14″ with an air flow conduit 15″ formed therein. The housing 14″ includes an inlet section 16″, a mixing and conditioning section 18″, and an outlet and distribution section (not shown). In the embodiment shown, an air inlet 22″ is formed in the inlet section 16″. The air inlet 22″ is in fluid communication with a supply of air (not shown). The supply of air can be provided from outside of the vehicle, recirculated from the passenger compartment of the vehicle, or a mixture of the two, for example. The inlet section 16″ is adapted to receive a blower wheel (not shown) therein to cause air to flow through the air inlet 22″. A filter (not shown) can be provided upstream, in, or downstream of the inlet section 16″ in respect of a direction of flow through the module 12″ if desired.

The mixing and conditioning section 18″ of the housing 14″ is configured to receive an evaporator core 24″ and a heater core 28″ therein. As shown, at least a portion of the mixing and conditioning section 18″ is divided into a first passage 30″ and a second passage 32″. In particular embodiments, the evaporator core 24″ is disposed upstream of a selectively positionable blend door 34″ in respect of the direction of flow through the module 12″ and the heater core 28″ is disposed in the second passage 32″ downstream of the blend door 34″ in respect of the direction of flow through the module 12″. A filter (not shown) can also be provided upstream of the evaporator core 24″ in respect of the direction of flow through the module 12″, if desired.

The evaporator core 24″ of the present invention is a multi-layer louvered-fin thermal energy exchanger. In a non-limiting example, the evaporator core 24″ has a first layer 40″, a second layer 42″, and a third layer 44″ arranged substantially perpendicular to the direction of flow through the module 12″. Additional or fewer layers than shown can be employed as desired. The layers 40″, 42″, 44″ are arranged so the second layer 42″ is disposed downstream of the first layer 40″ and upstream of the third layer 44″ in respect of the direction of flow through the module 12″. It is understood, however, that the layers 40″, 42″, 44″ can be arranged as desired. The layers 40″, 42″, 44″ can be bonded together by any suitable method as desired such as brazing and welding, for example.

In a particular embodiment, the layers 40″, 42″ of the evaporator core 24″, shown in FIG. 4, are in fluid communication with a first fluid source 70″ via a conduit 72″. The first fluid source 70″ includes a prime mover 74″ such as a compressor or a pump, for example, to cause a first fluid to circulate therein. Each of the layers 40″, 42″ is configured to receive a flow of the first fluid from the first fluid source 70″ therein. The first fluid absorbs thermal energy to condition the air flowing through the HVAC module 12″ when a fuel-powered engine of the vehicle, and thereby the prime mover 74″, is in operation. As a non-limiting example, the first fluid source 70″ is a refrigeration circuit, and the first fluid is a refrigerant such as R134a, HFO-1234yf, AC-5, AC-6, and CO₂, for example. A valve 76″ can be disposed in the conduit 72″ to selectively control the flow of the first fluid therethrough.

The HVAC system 10″ includes an internal thermal energy exchanger 78″ in fluid communication with a second fluid source 80″ via a conduit 82″. The second fluid source 80″ includes a prime mover 84″ (e.g. an electrical coolant pump) to cause a second fluid to circulate through the internal thermal energy exchanger 78″. As illustrated, the internal thermal energy exchanger 78″ is the layer 44″ of the evaporator core 24″. In other embodiments, the layers 40″, 44″ of the evaporator core 24″ are in fluid communication with the first fluid source 70″ and the internal thermal energy exchanger 78″ is the layer 42″ of the evaporator core 24″ in thermal energy exchange relationship with the second fluid source 80″. In yet other certain embodiments, only the layer 40″ of the evaporator core 24″ is in fluid communication with the first fluid source 70″ and the internal thermal energy exchanger 78″ is the layers 42″, 44″ of the evaporator core 24″ in thermal energy exchange relationship with the second fluid source 80″.

The internal thermal energy exchanger 78″ is configured to receive a flow of the second fluid from the second fluid source 80″ therein. The second fluid absorbs or releases thermal energy to condition the air flowing through the HVAC module 12″. A valve 86″ can be disposed in the conduit 82″ to selectively control the flow of the second fluid therethrough. As a non-limiting example, the second fluid source 80″ is a fluid reservoir containing a phase change material (PCM) therein. Those skilled in the art will appreciate that the phase change material can be any suitable material that melts and solidifies at predetermined temperatures and is capable of storing and releasing thermal energy such as organic, inorganic, eutectic and ionic liquids (e.g. a paraffin, a paraffin wax, an alcohol, water, a polygycol, a glycol), and the like, or any combination thereof, for example. The phase change material can also be impregnated with a thermally conductive material such as graphite powder, for example, to further enhance the transfer of thermal energy. As another non-limiting example, the second fluid source 80″ is a fluid reservoir containing a coolant therein. As another non-limiting example, the second fluid source 80″ is a fluid reservoir containing a phase change material coolant such as CryoSolplus, for example, therein. As yet another non-limiting example, the second fluid source 80″ is an external thermal energy exchanger (e.g. a shell and tube heat exchanger, a chiller, etc.) which includes a phase change material disposed therein and/or is in fluid communication with at least one other vehicle system.

In certain embodiments, the internal thermal energy exchanger 78″ is in thermal energy exchange relationship with an exhaust gas system 88″ of the vehicle via an external thermal energy exchanger 89″. Those skilled in the art will appreciate that the external thermal energy exchanger 89″ can be any suitable thermal energy exchanger such as an exhaust gas recirculation (EGR) thermal energy exchanger, for example. As illustrated, the external thermal energy exchanger 89″ is in fluid communication with the internal thermal energy exchanger 78″ and configured to receive, through a conduit 90″, a flow of the working fluid therein. A valve 91″ can be disposed in the conduit 90″ to selectively control the flow of the working fluid therethrough. The external thermal energy exchanger 89″ is also in fluid communication with the exhaust gas system 88″ and configured to receive, through a conduit 92″, a flow of an exhaust gas therein. As shown, the flow of the exhaust gas through the external thermal energy exchanger 89″ is counter to the flow of the working fluid therethrough. It is understood that the flow of the exhaust gas through the external thermal energy exchanger 89″ can be in any suitable flow direction in respect of the flow of the working fluid as desired such as a concurrent flow direction and a cross-flow direction, for example. A valve 93″ can be disposed in the conduit 92″ to selectively control the flow of the exhaust gas therethrough. The external thermal energy exchanger 89″ facilitates a transfer of thermal energy from the exhaust gas to heat the working fluid, especially when the fuel-powered engine of the vehicle is in operation. The exhaust gas is typically at a temperature in a range of about 400° C. to about 1000° C. As such, the working fluid is heated very rapidly and may heat the air flowing through the air flow conduit 15″ before the fuel-powered engine reaches a normal operating temperature. Accordingly, a size and capacity of the heater core 28″ may be decreased in respect of heater cores of the prior art, which may facilitate a decrease in air side pressure drop during heating modes of the HVAC system 10″, as well as an increase in available package space within the control module 12″.

As shown, the heater core 28″ is in fluid communication with a third fluid source 95″ via a conduit 96″. The heater core 28″ is configured to receive a flow of a third fluid from the third fluid source 95″ therein. The third fluid source 95″ can be any conventional source of heated fluid such as the fuel-powered engine or a battery system of the vehicle, for example, and the third fluid can be any conventional fluid such as a phase change material, a coolant, or a phase change material coolant, for example. A valve 97″ can be disposed in the conduit 96″ to selectively control the flow of the third fluid therethrough. The heater core 28″ is configured to facilitate a release of thermal energy from the third fluid to heat the air flowing therethrough when the fuel-powered engine of the vehicle is in operation.

A fourth fluid source 102″ is in fluid communication with the external thermal energy exchanger 89″ via the conduit 90″. The fourth fluid source 102″ is configured to receive a flow of a fourth fluid therein. In certain embodiments, the fourth fluid is the working fluid from the external thermal energy exchanger 89″. It is understood that any of the second fluid from the second fluid source 80″, the working fluid from the external thermal energy exchanger 89″, the third fluid from the third fluid source 95″, and the fourth fluid from the fourth fluid source 102″ may be the same or different fluid types if desired. As a non-limiting example, the fourth fluid source 102″ is a fluid reservoir containing a phase change material (PCM) therein. Those skilled in the art will appreciate that the phase change material can be any suitable material that melts and solidifies at predetermined temperatures and is capable of storing and releasing thermal energy such as organic, inorganic, eutectic and ionic liquids (e.g. a paraffin, a paraffin wax, an alcohol, water, a polygycol, a glycol), and the like, or any combination thereof, for example. The phase change material can also be impregnated with a thermally conductive material such as graphite powder, for example, to further enhance the transfer of thermal energy. As another non-limiting example, the fourth fluid source 102″ is a fluid reservoir containing a coolant therein. As another non-limiting example, the fourth fluid source 102″ is a fluid reservoir containing a phase change material coolant such as CryoSolplus, for example, therein. As yet another non-limiting example, the fourth fluid source 102″ is an external thermal energy exchanger (e.g. a shell and tube heat exchanger, a chiller, etc.) which includes a phase change material disposed therein.

As illustrated, the fourth fluid source 102″ is in thermal energy exchange relationship with an exhaust gas system 204 of the vehicle. It is understood that the exhaust gas system 204 can be separate from or at least a part of the exhaust gas system 88″. In certain embodiments, the fourth fluid source 102″ is in fluid communication with the exhaust gas system 204 and configured to receive, through a conduit 206, a flow of an exhaust gas therein. A valve 208 can be disposed in the conduit 206 to selectively control the flow of the exhaust gas therethrough. As shown, the flow of the exhaust gas through the fourth fluid source 102″ is counter to the flow of the fourth fluid therethrough. It is understood that the flow of the exhaust gas through the fourth fluid source 102″ can be in any suitable flow direction in respect of the flow of the working fluid as desired such as a concurrent flow direction and a cross-flow direction, for example. The fourth fluid source 102″ facilitates a transfer of thermal energy from the exhaust gas to heat the fourth fluid, especially when the fuel-powered engine of the vehicle is in operation. The exhaust gas is typically at a temperature in a range of about 400° C. to about 1000° C. As such, the fourth fluid is heated very rapidly and may heat the air flowing through the air flow conduit 15″ before the fuel-powered engine reaches a normal operating temperature. Accordingly, a size and capacity of the heater core 28″ may be decreased in respect of heater cores of the prior art, which may facilitate a decrease in air side pressure drop during heating modes of the HVAC system 10″, as well as an increase in available package space within the control module 12″.

In operation, the HVAC system 10″ conditions air by heating or cooling the air, and providing the conditioned air to the passenger compartment of the vehicle. Air from the supply of air is received in the inlet section 16″ of the housing 14″ in the air inlet 22″ and flows through the housing 14″ of the module 12″.

In each operating mode of the HVAC system 10″, the blend door 34″ may be positioned in one of a first position permitting air from the evaporator core 24″ and the internal thermal energy exchange 78″ to only flow into the first passage 30″, a second position permitting the air from the evaporator core 24″ and the internal thermal energy exchanger 78″ to only flow into the second passage 32″, and an intermediate position permitting the air from the evaporator core 24″ and the internal thermal energy exchanger 78″ to flow through both the first passage 30″ and the second passage 32″ and through the heater core 28″

When the fuel-powered engine of the vehicle is in operation and the HVAC system 10″ is operating in either a cooling mode or a cold thermal energy charge mode, the first fluid from the first fluid source 70″ circulates through the conduit 72″ to the evaporator core 24″. Additionally, the second fluid from the second fluid source 80″ circulates through the conduit 82″ to the internal thermal energy exchanger 78″. However, the valve 91″ is closed to militate against the circulation of the fourth fluid from the external thermal energy exchanger 89″ and the fourth fluid source 102″ through the conduit 90″ to the internal thermal energy exchanger 78″, the valve 93″ is closed to militate against the circulation of the exhaust gas from the exhaust gas system 88″ through the conduit 92″ to the external thermal energy exchanger 89″, the valve 208 is closed to militate against the circulation of the exhaust gas from the exhaust gas system 204 through the conduit 206 to the fourth fluid source 102″, and the valve 97″ is closed to militate against the circulation of the third fluid from the third fluid source 95″ through the conduit 96″ to the heater core 28″. Accordingly, the air from the inlet section 16″ flows into the evaporator core 24″ where the air is cooled to a desired temperature by a transfer of thermal energy from the air to the first fluid from the first fluid source 70″. The conditioned air then flows from the evaporator core 24″ to the internal thermal energy exchanger 78″. As the conditioned air flows through the internal thermal energy exchanger 78″, the conditioned air absorbs thermal energy from the second fluid. The transfer of thermal energy from the second fluid to the conditioned air cools the second fluid. The second fluid then flows to the second fluid source 80″ and absorbs thermal energy to cool or charge the phase change material, the coolant, the phase change material coolant, or any combination thereof contained in the second fluid source 80″. The conditioned air then exits the internal thermal energy exchanger 78″ and is selectively permitted by the blend door 34″ to flow through the first passage 30″ and/or the second passage 32″. It is understood, however, that in other embodiments the valve 97″ is open, permitting the third fluid from the third fluid source 95″ to circulate through the conduit 96″ to the heater core 28″, and thereby demist the conditioned air flowing through the second passage 32″.

In other certain embodiments, when the fuel-powered engine of the vehicle is in operation and the HVAC system 10″ is operating in an alternative cooling mode, the first fluid from the first fluid source 70″ circulates through the conduit 72″ to the evaporator core 24″. However, the valve 86″ is closed to militate against the circulation of the second fluid from the second fluid source 80″ through the conduit 82″ to the internal thermal energy exchanger 78″. Additionally, the valve 91″ is closed to militate against the circulation of the fourth fluid from the external thermal energy exchanger 89″ and the fourth fluid source 102″ through the conduit 90″ to the internal thermal energy exchanger 78″, the valve 93″ is closed to militate against the circulation of the exhaust gas from the exhaust gas system 88″ through the conduit 92″ to the external thermal energy exchanger 89″, the valve 208 is closed to militate against the circulation of the exhaust gas from the exhaust gas system 204 through the conduit 206 to the fourth fluid source 102″, and the valve 97″ is closed to militate against the circulation of the third fluid from the third fluid source 95″ through the conduit 96″ to the heater core 28″. Accordingly, the air from the inlet section 16″ flows into the evaporator core 24″ where the air is cooled to a desired temperature by a transfer of thermal energy from the air to the first fluid from the first fluid source 70″. The conditioned air then flows from the evaporator core 24″ to the internal thermal energy exchanger 78″. As the conditioned air flows through the internal thermal energy exchanger 78″, the temperature of the conditioned air is relatively unaffected. The conditioned air then exits the internal thermal energy exchanger 78″ and is selectively permitted by the blend door 34″ to flow through the first passage 30″ and/or the second passage 32″. It is understood, however, that in other embodiments the valve 97″ is open, permitting the third fluid from the third fluid source 95″ to circulate through the conduit 96″ to the heater core 28″, and thereby demist the conditioned air flowing through the second passage 32″.

When the fuel-powered engine of the vehicle is not in operation and the HVAC system 10″ is operating in an engine-off cooling mode, the first fluid from the first fluid source 70″ does not circulate through the conduit 72″ to the evaporator core 24″. Additionally, the valve 91″ is closed to militate against the circulation of the fourth fluid from the external thermal energy exchanger 89″ and the fourth fluid source 102″ through the conduit 90″ to the internal thermal energy exchanger 78″, the exhaust gas from the exhaust gas system 88″ does not circulate through the conduit 92″ to the external thermal energy exchanger 89″, the exhaust gas from the exhaust gas system 204 does not circulate through the conduit 206 to the fourth fluid source 102″, and the third fluid from the third fluid source 95″ does not circulate through the conduit 96″ to the heater core 28″. However, the second fluid from the second fluid source 80″ circulates through the conduit 82″ to the internal thermal energy exchanger 78″. Accordingly, the air from the inlet section 16″ flows through the evaporator core 24″ where a temperature of the air is relatively unaffected. The air then flows from the evaporator core 24″ to the internal thermal energy exchanger 78″. As the air flows through the internal thermal energy exchanger 78″, the air is cooled to a desired temperature by a transfer of thermal energy from the air to the second fluid from the second fluid source 80″. The conditioned air then exits the thermal energy exchanger 78″ and is selectively permitted by the blend door 34″ to flow through the first passage 30″ and/or the second passage 32″.

When the fuel-powered engine of the vehicle is in operation and the HVAC system 10″ is operating in a heating mode, the valve 76″ is closed to militate against the circulation of the first fluid from the first fluid source 70″ through the conduit 72″ to the evaporator core 24″. Similarly, the valve 86″ is closed to militate against the circulation of the second fluid from the second fluid source 80″ through the conduit 82″ to the internal thermal energy exchanger 78″. Additionally, the valve 91″ is closed to militate against the circulation of the fourth fluid from the external thermal energy exchanger 89″ and the fourth fluid source 102″ through the conduit 90″ to the internal thermal energy exchanger 78″, the valve 93″ is closed to militate against the circulation of the exhaust gas from the exhaust gas system 88″ through the conduit 92″ to the external thermal energy exchanger 89″, and the valve 208 is closed to militate against the circulation of the exhaust gas from the exhaust gas system 204 through the conduit 206 to the fourth fluid source 102″. However, the third fluid from the third fluid source 95″ circulates through the conduit 96″ to the heater core 28″. Accordingly, the air from the inlet section 16″ flows through the evaporator core 24″ and the internal thermal energy exchanger 78″ where a temperature of the air is relatively unaffected. The unconditioned air then exits the evaporator core 24″ and the internal thermal energy exchanger 78″ and is selectively permitted by the blend door 34″ to flow through the first passage 30″ and/or the second passage 32″ through the heater core 28″ to be heated to a desired temperature.

In other certain embodiments, when the fuel-powered engine of the vehicle is in operation and the HVAC system 10″ is operating in an alternative heating mode, the valve 76″ is closed to militate against the circulation of the first fluid from the first fluid source 70″ through the conduit 72″ to the evaporator core 24″. Similarly, the valve 86″ is closed to militate against the circulation of the second fluid from the second fluid source 80″ through the conduit 82″ to the internal thermal energy exchanger 78″, the valve 93″ is closed to militate against the circulation of the exhaust gas from the exhaust gas system 88″ through the conduit 92″ to the external thermal energy exchanger 89″, the valve 208 is closed to militate against the circulation of the exhaust gas from the exhaust gas system 204 through the conduit 206 to the fourth fluid source 102″, and the valve 97″ is closed to militate against the circulation of the third fluid from the third fluid source 95″ through the conduit 96″ to the heater core 28″. However, the fourth fluid from the fourth fluid source 102″ circulates through the conduit 90″ and the inoperative external thermal energy exchanger 89″ to the internal thermal energy exchanger 78″. Accordingly, the air from the inlet section 16″ flows through the evaporator core 24″ where a temperature of the air is relatively unaffected. The air then flows from the evaporator core 24″ to the internal thermal energy exchanger 78″. As the air flows through the internal thermal energy exchanger 78″, the air is heated to a desired temperature by a transfer of thermal energy from the fourth fluid from the fourth fluid source 102″ to the air flowing through the internal thermal energy exchanger 78″. In the fourth fluid source 102″, the fourth fluid absorbs thermal energy from the phase change material, the coolant, the phase change material coolant, or any combination thereof contained in the fourth fluid source 102″ to heat the fourth fluid. The conditioned air then exits the internal thermal energy exchanger 78″ and is selectively permitted by the blend door 34″ to flow through the first passage 30″ and/or the second passage 32″. It is understood, however, that in other embodiments the valve 93″ is open permitting the circulation of the exhaust gas from the exhaust gas system 88″ through the conduit 92″ to the external thermal energy exchanger 89″ to transfer thermal energy to the fourth fluid from the fourth fluid source 102″ and/or the valve 208 is open permitting the circulation of the exhaust gas from the exhaust gas system 204 through the conduit 206 to the fourth fluid source 102″ to transfer thermal energy to the fourth fluid from the fourth fluid source 102″. IT is further understood that in other embodiments the valve 97″ is open, permitting the third fluid from the third fluid source 95″ to circulate through the conduit 96″ to the heater core 28″, and thereby further heat the conditioned air flowing through the second passage 32″ to a desired temperature.

In other certain embodiments, when the fuel-powered engine of the vehicle is in operation and the HVAC system 10″ is operating in another alternative heating mode or a hot thermal energy charge mode, the valve 76″ is closed to militate against the circulation of the first fluid from the first fluid source 70″ through the conduit 72″ to the evaporator core 24″. Similarly, the valve 86″ is closed to militate against the circulation of the second fluid from the second fluid source 80″ through the conduit 82″ to the internal thermal energy exchanger 78″ and the valve 97″ is closed to militate against the circulation of the third fluid from the third fluid source 95″ through the conduit 96″ to the heater core 28″. However, the fourth fluid from the fourth fluid source 102″ circulates through the conduit 90″ and the external thermal energy exchanger 89″, and through the fourth fluid source 102″ to the internal thermal energy exchanger 78″. At least one of the exhaust gas from the exhaust gas system 88″ circulates through the conduit 92″ to the external thermal energy exchanger 89″ and the exhaust gas from the exhaust gas system 204 circulates through the conduit 206 to the fourth fluid source 102″ to heat the fourth fluid. In the fourth fluid source 102″, the fourth fluid, which has been heated by the exhaust gas from at least one of the exhaust gas systems 88″, 204, transfers thermal energy to heat or charge the phase change material, the coolant, the phase change material coolant, or any combination thereof contained in the fourth fluid source 102″. Accordingly, the air from the inlet section 16″ flows through the evaporator core 24″ where a temperature of the air is relatively unaffected. The air then flows from the evaporator core 24″ to the internal thermal energy exchanger 78″. As the air flows through the internal thermal energy exchanger 78″, the air is heated to a desired temperature by a transfer of thermal energy from the fourth fluid to the air flowing through the internal thermal energy exchanger 78″. The conditioned air then exits the internal thermal energy exchanger 78″ and is selectively permitted by the blend door 34″ to flow through the first passage 30″ and/or the second passage 32″. It is understood, however, that in other embodiments the valve 97″ is open, permitting the third fluid from the third fluid source 95″ to circulate through the conduit 96″ to the heater core 28″, and thereby further heat the conditioned air flowing through the second passage 32″ to a desired temperature

In other certain embodiments, when the fuel-powered engine of the vehicle is in operation and the HVAC system 10″ is operating in an alternative hot thermal energy charge mode, the valve 76″ is closed to militate against the circulation of the first fluid from the first fluid source 70″ through the conduit 72″ to the evaporator core 24″. Similarly, the valve 86″ is closed to militate against the circulation of the second fluid from the second fluid source 80″ through the conduit 82″ to the internal thermal energy exchanger 78″, the valve 91″ is closed to militate against the circulation of the fourth fluid from the fourth fluid source 102″ through the conduit 90″ to the internal thermal energy exchanger 78″, and the valve 97″ is closed to militate against the circulation of the third fluid from the third fluid source 95″ through the conduit 96″ to the heater core 28″. Additionally, the valve 93″ is closed to militate against the circulation of the exhaust gas from the exhaust gas system 88″ to the external thermal energy exchanger 89″. However, the exhaust gas from the exhaust gas system 204 circulates through the conduit 206 to the fourth fluid source 102″ to heat or charge the phase change material, the coolant, the phase change material coolant, or any combination thereof contained in the fourth fluid source 102″. Accordingly, the air from the inlet section 16″ flows through the evaporator core 24″ and the internal thermal energy exchanger 78″ where a temperature of the air is relatively unaffected. The unconditioned air then exits the internal thermal energy exchanger 78″ and is selectively permitted by the blend door 34″ to flow through the first passage 30″ and/or the second passage 32″. It is understood, however, that in other embodiments the valve 97″ is open, permitting the third fluid from the third fluid source 95″ to circulate through the conduit 96″ to the heater core 28″, and thereby heat the unconditioned air flowing through the second passage 32″ to a desired temperature.

When the fuel-powered engine of the vehicle is not in operation and the HVAC system 10″ is operating in an engine-off heating mode, the first fluid from the first fluid source 70″ does not circulate through the conduit 72″ to the evaporator core 24″. Similarly, the valve 86″ is closed to militate against the circulation of the second fluid from the second fluid source 80″ through the conduit 82″ to the internal thermal energy exchanger 78″. Additionally, the exhaust gas from the exhaust gas system 88″ does not circulate through the conduit 92″ to the external thermal energy exchanger 89″, the exhaust gas from the exhaust gas system 204 does not circulate through the conduit 206 to the fourth fluid source 102″, and the third fluid from the third fluid source 95″ does not circulate through the conduit 96″ to the heater core 28″. However, the fourth fluid from the fourth fluid source 102″ circulates through the conduit 90″ and the inoperative external thermal energy exchanger 89″, and through the fourth fluid source 102″ to the internal thermal energy exchanger 78″. In the fourth fluid source 102″, the fourth fluid is heated by the phase change material, the coolant, the phase change material coolant, or any combination thereof contained in the fourth fluid source 102″. Accordingly, the air from the inlet section 16″ flows through the evaporator core 24″ where a temperature of the air is relatively unaffected. The air then flows from the evaporator core 24″ to the internal thermal energy exchanger 78″. As the air flows through the internal thermal energy exchanger 78″, the air is heated to a desired temperature by a transfer of thermal energy from the fourth fluid from the fourth fluid source 102″ to the air flowing through the internal thermal energy exchanger 78″. The conditioned air then exits the thermal energy exchanger 78″ and is selectively permitted by the blend door 34″ to flow through the first passage 30″ and/or the second passage 32″.

When the fuel-powered engine of the vehicle is in operation and the HVAC system 10″ is operating in a recirculation heating mode or another alternative hot thermal energy charge mode, the valve 76″ is closed to militate against the circulation of the first fluid from the first fluid source 70″ through the conduit 72″ to the evaporator core 24″. Similarly, the valve 86″ is closed to militate against the circulation of the second fluid from the second fluid source 80″ through the conduit 82″ to the internal thermal energy exchanger 78″. Additionally, the valve 91″ is closed to militate against the circulation of the fourth fluid to the internal thermal energy exchanger 78″, the valve 93″ is closed to militate against the circulation of the exhaust gas from the exhaust gas system 88″ through the conduit 92″ to the external thermal energy exchanger 89″, the valve 208 is closed to militate against the circulation of the exhaust gas from the exhaust gas system 204 through the conduit 206 to the fourth fluid source 102″, and the valve 97″ is closed to militate against the circulation of the third fluid from the third fluid source 95″ through the conduit 96″ to the heater core 28″. Accordingly, a re-circulated air from a passenger compartment of the vehicle flows through the inlet section 16″, through the evaporator core 24″, and into the internal thermal energy exchanger 78″ where a temperature of the air is relatively unaffected. The re-circulated air then exits the internal thermal energy exchanger 78″ and is selectively permitted by the blend door 34″ to flow through the first passage 30″ and/or the second passage 32″. It is understood, however, that in other embodiments the valve 91″ is open permitting the fourth fluid heated by at least one of the exhaust gas from the exhaust gas system 88″, the exhaust gas from the exhaust gas system 204, and the phase change material, the coolant, the phase change material coolant, or any combination thereof contained in the fourth fluid source 102″ to circulate through the conduit 90″ to the internal thermal energy exchanger 78″ and/or the valve 97″ is open permitting the third fluid from the third fluid source 95″ to circulate through the conduit 96″ to the heater core 28″, and thereby heat the re-circulated air flowing through the first passage 30″ and/or the second passage 32″. It is further understood that the valve 91″ is open permitting the fourth fluid to absorb thermal energy from air flowing through the internal thermal energy exchanger 78″, and thereby heat or charge the phase change material, the coolant, the phase change material coolant, or any combination thereof contained in the fourth fluid source 102″.

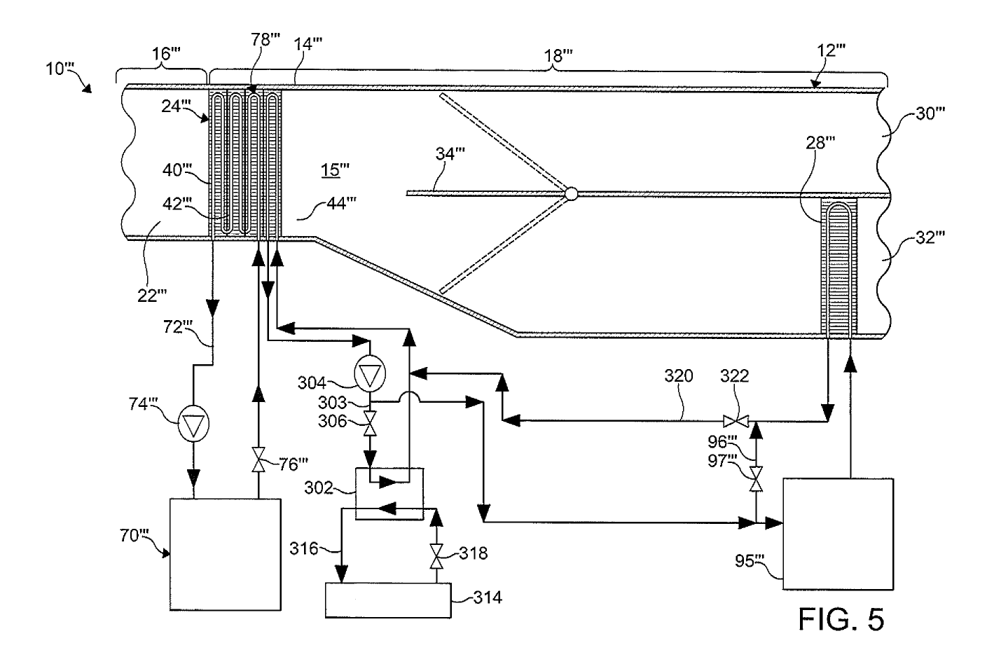

FIG. 5 shows an alternative embodiment of the HVAC systems 10, 10′, 10″ illustrated in FIGS. 1 and 3-4. Structure similar to that illustrated in FIGS. 1-4 includes the same reference numeral and a triple prime (′″) symbol for clarity.

In FIG. 5, the HVAC system 10′″ includes a control module 12′″ to control at least a temperature of the passenger compartment. The module 12′″ illustrated includes a hollow main housing 14′″ with an air flow conduit 15′″ formed therein. The housing 14′″ includes an inlet section 16′″, a mixing and conditioning section 18′″, and an outlet and distribution section (not shown). In the embodiment shown, an air inlet 22′″ is formed in the inlet section 16′″. The air inlet 22′″ is in fluid communication with a supply of air (not shown). The supply of air can be provided from outside of the vehicle, recirculated from the passenger compartment of the vehicle, or a mixture of the two, for example. The inlet section 16′″ is adapted to receive a blower wheel (not shown) therein to cause air to flow through the air inlet 22′″. A filter (not shown) can be provided upstream, in, or downstream of the inlet section 16′″ in respect of a direction of flow through the module 12′″ if desired.

The mixing and conditioning section 18′″ of the housing 14′″ is configured to receive an evaporator core 24′″ and a heater core 28′″ therein. As shown, at least a portion of the mixing and conditioning section 18′″ is divided into a first passage 30′″ and a second passage 32′″. In particular embodiments, the evaporator core 24′″ is disposed upstream of a selectively positionable blend door 34′″ in respect of the direction of flow through the module 12′″ and the heater core 28′″ is disposed in the second passage 32′″ downstream of the blend door 34′″ in respect of the direction of flow through the module 12′″. A filter (not shown) can also be provided upstream of the evaporator core 24′″ in respect of the direction of flow through the module 12′″, if desired.

The evaporator core 24′″ of the present invention is a multi-layer louvered-fin thermal energy exchanger. In a non-limiting example, the evaporator core 24″ has a first layer 40′″, a second layer 42′″, and a third layer 44′″ arranged substantially perpendicular to the direction of flow through the module 12′″. Additional or fewer layers than shown can be employed as desired. The layers 40′″, 42′″, 44′″ are arranged so the second layer 42′″ is disposed downstream of the first layer 40′″ and upstream of the third layer 44′″ in respect of the direction of flow through the module 12′″. It is understood, however, that the layers 40′″, 42′″, 44′″ can be arranged as desired. The layers 40′″, 42′″, 44′″ can be bonded together by any suitable method as desired such as brazing and welding, for example.

In a particular embodiment, the layers 40′″, 42′″ of the evaporator core 24′″, shown in FIG. 5, are in fluid communication with a first fluid source 70′″ via a conduit 72′″. The first fluid source 70′″ includes a prime mover 74′″ such as a compressor or a pump, for example, to cause a first fluid to circulate therein. Each of the layers 40′″, 42′″ is configured to receive a flow of the first fluid from the first fluid source 70′″ therein. The first fluid absorbs thermal energy to condition the air flowing through the HVAC module 12′″ when a fuel-powered engine of the vehicle, and thereby the prime mover 74′″, is in operation. As a non-limiting example, the first fluid source 70′″ is a refrigeration circuit, and the first fluid is a refrigerant such as R134a, HFO-1234yf, AC-5, AC-6, and CO₂, for example. A valve 76′″ can be disposed in the conduit 72′″ to selectively control the flow of the first fluid therethrough.

The HVAC system 10′″ includes an internal thermal energy exchanger 78′″ in fluid communication with a second fluid source 302 via a conduit 303. The second fluid source 302 includes a prime mover 304 (e.g. an electrical coolant pump) to cause a second fluid to circulate through the internal thermal energy exchanger 78′″. As illustrated, the internal thermal energy exchanger 78′″ is the layer 44′″ of the evaporator core 24′″. In other embodiments, the layers 40′″, 44′″ of the evaporator core 24′″ are in fluid communication with the first fluid source 70′″ and the internal thermal energy exchanger 78′″ is the layer 42′″ of the evaporator core 24′″ in thermal energy exchange relationship with the second fluid source 302. In yet other certain embodiments, only the layer 40′″ of the evaporator core 24′″ is in fluid communication with the first fluid source 70′″ and the internal thermal energy exchanger 78′″ is the layers 42′″, 44′″ of the evaporator core 24′″ in thermal energy exchange relationship with the second fluid source 302.

The internal thermal energy exchanger 78′″ is configured to receive a flow of the second fluid from the second fluid source 302 therein. The second fluid absorbs or releases thermal energy to condition the air flowing through the HVAC module 12′″. A valve 306 can be disposed in the conduit 303 to selectively control the flow of the second fluid therethrough. As a non-limiting example, the second fluid source 302 is a fluid reservoir containing a phase change material (PCM) therein. Those skilled in the art will appreciate that the phase change material can be any suitable material that melts and solidifies at predetermined temperatures and is capable of storing and releasing thermal energy such as organic, inorganic, eutectic and ionic liquids (e.g. a paraffin, a paraffin wax, an alcohol, water, a polygycol, a glycol), and the like, or any combination thereof, for example. The phase change material can also be impregnated with a thermally conductive material such as graphite powder, for example, to further enhance the transfer of thermal energy. As another non-limiting example, the second fluid source 302 is a fluid reservoir containing a coolant therein. As another non-limiting example, the second fluid source 302 is a fluid reservoir containing a phase change material coolant such as CryoSolplus, for example, therein. As yet another non-limiting example, the second fluid source 302 is an external thermal energy exchanger (e.g. a shell and tube heat exchanger, a chiller, etc.) which includes a phase change material disposed therein and/or is in fluid communication with at least one other vehicle system.

As illustrated, the second fluid source 302 is in thermal energy exchange relationship with an exhaust gas system 314 of the vehicle. In certain embodiments, the second fluid source 302 is in fluid communication with the exhaust gas system 314 and configured to receive, through a conduit 316, a flow of an exhaust gas therein. A valve 318 can be disposed in the conduit 316 to selectively control the flow of the exhaust gas therethrough. As shown, the flow of the exhaust gas through the second fluid source 302 is counter to the flow of the second fluid therethrough. It is understood that the flow of the exhaust gas through the second fluid source 302 can be in any suitable flow direction in respect of the flow of the working fluid as desired such as a concurrent flow direction and a cross-flow direction, for example. The second fluid source 302 facilitates a transfer of thermal energy from the exhaust gas to heat the second fluid, especially when the fuel-powered engine of the vehicle is in operation. The exhaust gas is typically at a temperature in a range of about 400° C. to about 1000° C. As such, the second fluid is heated very rapidly and may heat the air flowing through the air flow conduit 15′″ before the fuel-powered engine reaches a normal operating temperature. Accordingly, a size and capacity of the heater core 28′″ may be decreased in respect of heater cores of the prior art, which may facilitate a decrease in air side pressure drop during heating modes of the HVAC system 10′″, as well as an increase in available package space within the control module 12′″.

As shown, the heater core 28′″ is in fluid communication with a third fluid source 95′″ via a conduit 96′″. The heater core 28′″ is configured to receive a flow of a third fluid from the third fluid source 95′″ therein. The third fluid source 95′″ can be any conventional source of heated fluid such as the fuel-powered engine or a battery system of the vehicle, for example, and the third fluid can be any conventional fluid such as a phase change material, a coolant, or a phase change material coolant, for example. A valve 97′″ can be disposed in the conduit 96′″ to selectively control the flow of the third fluid therethrough. The heater core 28′″ is configured to facilitate a release of thermal energy from the third fluid to heat the air flowing therethrough when the fuel-powered engine of the vehicle is in operation.

In certain embodiments, the heater core 28′″ and the third fluid source 95′″ are also in fluid communication with the internal thermal energy exchanger 78′″ via a conduit 320. The internal thermal energy exchanger 78′″ is configured to facilitate a release of thermal energy from the third fluid to heat the air flowing therethrough. Accordingly, a size and capacity of the heater core 28′″ may be further decreased in respect of heater cores of the prior art, which may facilitate a further decrease in air side pressure drop during heating modes of the HVAC system 10′″, as well as a further increase in available package space within the control module 12′″. A valve 322 can be disposed in the conduit 320 to selectively militate against the flow of the third fluid therethrough. As a non-limiting example, the second fluid from the second fluid source 302 and the third fluid from the third fluid source 95′″ are the same fluid types. It is understood, however, that the second fluid from the second fluid source 302 and the third fluid from the third fluid source 95′″ may be different fluid types if desired.

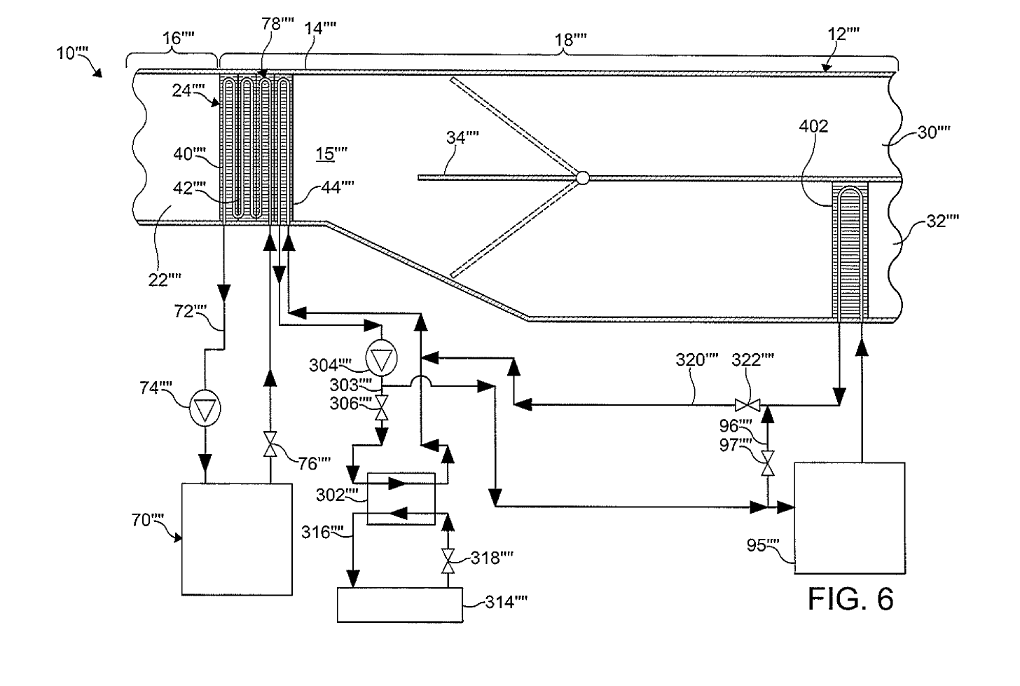

FIG. 6 shows another alternative embodiment of the HVAC systems 10, 10′, 10″, 10′″ illustrated in FIGS. 1 and 3-5. Structure similar to that illustrated in FIGS. 1-5 includes the same reference numeral and a quadruple prime (″″) symbol for clarity. In FIG. 6, the HVAC system 10″″ is substantially similar to the HVAC systems 10, 10′, 10″, 10′″ except the second fluid source 302″″ is a thermal energy exchanger (e.g. a gas-to-liquid thermal energy exchanger) in thermal energy exchange relationship with the exhaust gas system 314′″.

It is understood that the operation of the HVAC system 10″″ is substantially similar to the operation of the HVAC system 10″. For simplicity, only the operation of the HVAC system 10′″ is described hereinafter.

In operation, the HVAC system 10′″ conditions air by heating or cooling the air, and providing the conditioned air to the passenger compartment of the vehicle. Air from the supply of air is received in the inlet section 16′″ of the housing 14′″ in the air inlet 22′″ and flows through the housing 14′″ of the module 12′″.

In each operating mode of the HVAC system 10′″, the blend door 34′″ may be positioned in one of a first position permitting air from the evaporator core 24′″ and the internal thermal energy exchange 78′″ to only flow into the first passage 30′″, a second position permitting the air from the evaporator core 24′″ and the internal thermal energy exchanger 78′″ to only flow into the second passage 32′″, and an intermediate position permitting the air from the evaporator core 24′″ and the internal thermal energy exchanger 78′″ to flow through both the first passage 30′″ and the second passage 32′″ and through the heater core 28′″.

When the fuel-powered engine of the vehicle is in operation and the HVAC system 10′″ is operating in either a cooling mode or a cold thermal energy charge mode, the first fluid from the first fluid source 70′″ circulates through the conduit 72′″ to the evaporator core 24′″. Additionally, the second fluid from the second fluid source 302 circulates through the conduit 303 to the internal thermal energy exchanger 78′″. However, the valve 318 is closed to militate against the circulation of the exhaust gas from the exhaust gas system 314 through the conduit 316 to the second fluid source 302 and the valves 97′″, 322 are closed to militate against the circulation of the third fluid from the third fluid source 95′″ through the conduit 96′″ to the heater core 28′″ and through the conduit 320 to the internal thermal energy exchanger 78′″. Accordingly, the air from the inlet section 16′″ flows into the evaporator core 24′″ where the air is cooled to a desired temperature by a transfer of thermal energy from the air to the first fluid from the first fluid source 70′″. The conditioned air then flows from the evaporator core 24′″ to the internal thermal energy exchanger 78′″. As the conditioned air flows through the internal thermal energy exchanger 78′″, the conditioned air absorbs thermal energy from the second fluid. The transfer of thermal energy from the second fluid to the conditioned air cools the second fluid. The second fluid then flows to the second fluid source 302 and absorbs thermal energy to cool or charge the phase change material, the coolant, the phase change material coolant, or any combination thereof contained in the second fluid source 302. The conditioned air then exits the internal thermal energy exchanger 78′″ and is selectively permitted by the blend door 34′″ to flow through the first passage 30′″ and/or the second passage 32′″. It is understood, however, that in other embodiments the valve 97′″ is open, permitting the third fluid from the third fluid source 95′″ to circulate through the conduit 96′″ to the heater core 28′″, and thereby demist the conditioned air flowing through the second passage 32′″.

In other certain embodiments, when the fuel-powered engine of the vehicle is in operation and the HVAC system 10′″ is operating in an alternative cooling mode, the first fluid from the first fluid source 70′″ circulates through the conduit 72′″ to the evaporator core 24′″. However, the valve 306 is closed to militate against the circulation of the second fluid from the second fluid source 302 through the conduit 303 to the internal thermal energy exchanger 78′″. Additionally, the valve 318 is closed to militate against the circulation of the exhaust gas from the exhaust gas system 314 through the conduit 316 to the second fluid source 302 and the valves 97′″, 322 are closed to militate against the circulation of the third fluid from the third fluid source 95′″ through the conduit 96′″ to the heater core 28′″ and through the conduit 320 to the internal thermal energy exchanger 78′″. Accordingly, the air from the inlet section 16′″ flows into the evaporator core 24′″ where the air is cooled to a desired temperature by a transfer of thermal energy from the air to the first fluid from the first fluid source 70′″. The conditioned air then flows from the evaporator core 24′″ to the internal thermal energy exchanger 78′″. As the conditioned air flows through the internal thermal energy exchanger 78′″, the temperature of the conditioned air is relatively unaffected. The conditioned air then exits the internal thermal energy exchanger 78′″ and is selectively permitted by the blend door 34′″ to flow through the first passage 30′″ and/or the second passage 32′″. It is understood, however, that in other embodiments the valve 97′″ is open, permitting the third fluid from the third fluid source 95′″ to circulate through the conduit 96′″ to the heater core 28′″, and thereby demist the conditioned air flowing through the second passage 32′″.

When the fuel-powered engine of the vehicle is not in operation and the HVAC system 10′″ is operating in an engine-off cooling mode, the first fluid from the first fluid source 70′″ does not circulate through the conduit 72′″ to the evaporator core 24′″. Additionally, the exhaust gas from the exhaust gas system 314 does not circulate through the conduit 316 to the second fluid source 302 and the third fluid from the third fluid source 95′″ does not circulate through the conduit 96′″ to the heater core 28′″ or through the conduit 320 to the internal thermal energy exchanger 78′″. However, the second fluid from the second fluid source 302 circulates through the conduit 303 to the internal thermal energy exchanger 78′″. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is cooled to a desired temperature by a transfer of thermal energy from the air to the second fluid from the second fluid source 302. The conditioned air then exits the thermal energy exchanger 78′″ and is selectively permitted by the blend door 34′″ to flow through the first passage 30′″ and/or the second passage 32′″.

When the fuel-powered engine of the vehicle is in operation and the HVAC system 10′″ is operating in a heating mode, the valve 76′″ is closed to militate against the circulation of the first fluid from the first fluid source 70′″ through the conduit 72′″ to the evaporator core 24′″. Similarly, the valve 306 is closed to militate against the circulation of the second fluid from the second fluid source 302 through the conduit 303 to the internal thermal energy exchanger 78′″. Additionally, the valve 318 is closed to militate against the circulation of the exhaust gas from the exhaust gas system 314 through the conduit 316 to the second fluid source 302 and the valve 322 is closed to militate against the circulation of the third fluid from the third fluid source 95′″ through the conduit 320 to the internal thermal energy exchanger 78′″. However, the third fluid from the third fluid source 95′″ circulates through the conduit 96′″ to the heater core 28′″. Accordingly, the air from the inlet section 16′″ flows through the evaporator core 24′″ and the internal thermal energy exchanger 78′″ where a temperature of the air is relatively unaffected. The unconditioned air then exits the evaporator core 24′″ and the internal thermal energy exchanger 78′″ and is selectively permitted by the blend door 34′″ to flow through the first passage 30′″ and/or the second passage 32′″ through the heater core 28′″ to be heated to a desired temperature.

When the fuel-powered engine of the vehicle is in operation and the HVAC system 10′″ is operating in an alternative heating mode, the valve 76′″ is closed to militate against the circulation of the first fluid from the first fluid source 70′″ through the conduit 72′″ to the evaporator core 24′″. Similarly, the valve 306 is closed to militate against the circulation of the second fluid from the second fluid source 302 through the conduit 303 to the internal thermal energy exchanger 78′″. Additionally, the valve 318 is closed to militate against the circulation of the exhaust gas from the exhaust gas system 314 through the conduit 316 to the second fluid source 302. However, the third fluid from the third fluid source 95′″ circulates through the respective conduits 96′″, 320 to the heater core 28′″ and the internal thermal energy exchanger 78′″. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is heated to a desired temperature by a transfer of thermal energy from the third fluid from the third fluid source 95′″ to the air flowing through the internal thermal energy exchanger 78′″. The conditioned air then exits the internal thermal energy exchanger 78′″ and is selectively permitted by the blend door 34′″ to flow through the first passage 30′″ and/or the second passage 32′″ through the heater core 28′″ to be further heated to a desired temperature.

In other certain embodiments, when the fuel-powered engine of the vehicle is in operation and the HVAC system 10′″ is operating in an alternative heating mode, the valve 76′″ is closed to militate against the circulation of the first fluid from the first fluid source 70′″ through the conduit 72′″ to the evaporator core 24′″. Similarly, the valve 318 is closed to militate against the circulation of the exhaust gas from the exhaust gas system 314 through the conduit 316 to the second fluid source 302 and the valves 97′″, 322 are closed to militate against the circulation of the third fluid from the third fluid source 95′″ through the respective conduits 96′″, 320 to the heater core 28′″ and the internal thermal energy exchanger 78′″. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is heated to a desired temperature by a transfer of thermal energy from the second fluid from the second fluid source 302 to the air flowing through the internal thermal energy exchanger 78′″. In the second fluid source 302, the second fluid absorbs thermal energy from the phase change material, the coolant, the phase change material coolant, or any combination thereof contained in the second fluid source 302 to heat the second fluid. The conditioned air then exits the internal thermal energy exchanger 78′″ and is selectively permitted by the blend door 34′″ to flow through the first passage 30′″ and/or the second passage 32′″. It is understood, however, that in other embodiments the valve 318 is open permitting the circulation of the exhaust gas from the exhaust gas system 314 through the conduit 316 to the second fluid source 302 to transfer thermal energy to the second fluid from the second fluid source 302. It is further understood that in other embodiments the valve 97′″ is open, permitting the third fluid from the third fluid source 95′″ to circulate through the conduit 96′″ to the heater core 28′″, and thereby further heat the conditioned air flowing through the second passage 32′″ to a desired temperature.

In other certain embodiments, when the fuel-powered engine of the vehicle is in operation and the HVAC system 10′″ is operating in another alternative heating mode, the valve 76′″ is closed to militate against the circulation of the first fluid from the first fluid source 70′″ through the conduit 72′″ to the evaporator core 24′″. Similarly, the valve 306 is closed to militate against the circulation of the second fluid from the second fluid source 302 through the conduit 303 to the internal thermal energy exchanger 78′″, the valve 318 is closed to militate against the circulation of the exhaust gas from the exhaust gas system 314 through the conduit 316 to the second fluid source 302, and the valve 97′″ is closed to militate against the circulation of the third fluid from the third fluid source 95′″ through the conduit 96′″ to the heater core 28′″. However, the third fluid from the third fluid source 95′″ circulates through the conduit 320 to the internal thermal energy exchanger 78′″. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is heated to a desired temperature by a transfer of thermal energy from the third fluid to the air flowing through the internal thermal energy exchanger 78′″. The conditioned air then exits the internal thermal energy exchanger 78′ and is selectively permitted by the blend door 34′″ to flow through the first passage 30′″ and/or the second passage 32′″. It is understood, however, that in other embodiments the valve 97′″ is open, permitting the third fluid from the third fluid source 95′″ to circulate through the conduit 96′″ to the heater core 28′″, and thereby further heat the conditioned air flowing through the second passage 32′″ to a desired temperature.

In other certain embodiments, when the fuel-powered engine of the vehicle is in operation and the HVAC system 10′″ is operating in another alternative heating mode or a hot thermal energy charge mode, the valve 76′″ is closed to militate against the circulation of the first fluid from the first fluid source 70′″ through the conduit 72′″ to the evaporator core 24′″. Similarly, the valve 318 is closed to militate against the circulation of the exhaust gas from the exhaust gas source 314 through the conduit 316 to the second fluid source 302. However, the second fluid from the second fluid source 302 circulates through the conduit 303 to the internal thermal energy exchanger 78′″ and the third fluid from the third fluid source 95′″ circulates through the respective conduits 96′″, 320 to the heater core 28′″ and the internal thermal energy exchanger 78′″. The second fluid mixes with the third fluid before, in, or after flowing through the internal thermal energy exchanger 78′″. Accordingly, the air from the inlet section 16′″ flows through the evaporator core 24′″ where a temperature of the air is relatively unaffected. The unconditioned air then flows from the evaporator core 24′″ to the internal thermal energy exchanger 78′″. As the air flows through the internal thermal energy exchanger 78′″, the air is heated to a desired temperature by a transfer of thermal energy from the mixture of the second fluid and the third fluid to the air flowing through the internal thermal energy exchanger 78′″. The mixture of the second fluid and the third fluid then flows to the second fluid source 302 to heat or charge the phase change material, the coolant, the phase change material coolant, or any combination thereof contained in the second fluid source 302. The conditioned air then exits the internal thermal energy exchanger 78′″ and is selectively permitted by the blend door 34′″ to flow through the first passage 30′″ and/or the second passage 32′″ through the heater core 28′″ to be further heated to a desired temperature. It is understood, however, that in other embodiments the valve 318 is open, permitting the exhaust gas from the exhaust gas system 314 to circulate through the conduit 316 to the second fluid source 302, and thereby further heat the second fluid.

In other certain embodiments, when the fuel-powered engine of the vehicle is in operation and the HVAC system 10′″ is operating in another alternative heating mode or a hot thermal energy charge mode, the valve 76′″ is closed to militate against the circulation of the first fluid from the first fluid source 70′″ through the conduit 72′″ to the evaporator core 24′″. Similarly, the valve 306 is closed to militate against the circulation of the second fluid from the second fluid source 302 through the conduit 303 to the internal thermal energy exchanger 78′″, the valve 322 is closed to militate against the circulation of the third fluid from the third fluid source 95′″ through the conduit 320 to the internal thermal energy exchanger 78′″, and the valve 97′″ is closed to militate against the circulation of the third fluid from the third fluid source 95′″ through the conduit 96′″ to the heater core 28′″. However, the exhaust gas from the exhaust gas system 314 circulates through the conduit 316 to the second fluid source 302 to heat or charge the phase change material, the coolant, the phase change material coolant, or any combination thereof contained in the second fluid source 302. Accordingly, the air from the inlet section 16′″ flows through the evaporator core 24′″ and the internal thermal energy exchanger 78′″ where a temperature of the air is relatively unaffected. The unconditioned air then exits the internal thermal energy exchanger 78′″ and is selectively permitted by the blend door 34′″ to flow through the first passage 30′″ and/or the second passage 32′″. It is understood, however, that in other embodiments the valve 97′″ is open, permitting the third fluid from the third fluid source 95′″ to circulate through the conduit 96′″ to the heater core 28′″, and thereby heat the unconditioned air flowing through the second passage 32′″ to a desired temperature.

When the fuel-powered engine of the vehicle is not in operation and the HVAC system 10′″ is operating in an engine-off heating mode, the first fluid from the first fluid source 70′″ does not circulate through the conduit 72′″ to the evaporator core 24′″. The exhaust gas from the exhaust gas system 314 does not circulate through the conduit 316 to the second fluid source 302 and the third fluid from the third fluid source 95′″ does not circulate through the respective conduit 96′″, 320 to the heater core 28′″ and the internal thermal energy exchanger 78′″. However, the second fluid from the second fluid source 302 circulates through the conduit 313 to the internal thermal energy exchanger 78′″. In the second fluid source 302, the second fluid is heated by the phase change material, the coolant, the phase change material coolant, or any combination thereof contained in the second fluid source 302. Accordingly, the air from the inlet section 16′″ flows through the evaporator core 24′″ where a temperature of the air is relatively unaffected. The air then flows from the evaporator core 24′″ to the internal thermal energy exchanger 78′″. As the air flows through the internal thermal energy exchanger 78′″, the air is heated to a desired temperature by a transfer of thermal energy from the second fluid from the second fluid source 302 to the air flowing through the internal thermal energy exchanger 78′″. The conditioned air then exits the thermal energy exchanger 78′″ and is selectively permitted by the blend door 34′″ to flow through the first passage 30′″ and/or the second passage 32′″.

When the fuel-powered engine of the vehicle is in operation and the HVAC system 10′″ is operating in a recirculation heating mode or another alternative hot thermal energy charge mode, the valve 76′″ is closed to militate against the circulation of the first fluid from the first fluid source 70′″ through the conduit 72′″ to the evaporator core 24′″. Similarly, the valve 306 is closed to militate against the circulation of the second fluid from the second fluid source 302 through the conduit 303 to the internal thermal energy exchanger 78′″. Additionally, the valve 318 is closed to militate against the circulation of the exhaust gas from the exhaust gas system 314 through the conduit 318 to the second fluid source 302, and the valves 97′″, 322 are closed to militate against the circulation of the third fluid from the third fluid source 95′″ through the respective conduits 96′″, 320 to the heater core 28′″ and the internal thermal energy exchanger 78′″. Accordingly, a re-circulated air from a passenger compartment of the vehicle flows through the inlet section 16′″, through the evaporator core 24′″, and into the internal thermal energy exchanger 78′″ where a temperature of the air is relatively unaffected. The re-circulated air then exits the internal thermal energy exchanger 78′″ and is selectively permitted by the blend door 34 to flow through the first passage 30′″ and/or the second passage 32′″. It is understood, however, that in other embodiments the valve 306 is open permitting the second fluid heated by at least one of the exhaust gas from the exhaust gas system 314, and the phase change material, the coolant, the phase change material coolant, or any combination thereof contained in the second fluid source 302 to circulate through the conduit 303 to the internal thermal energy exchanger 78′″, the valve 97′″ is open permitting the third fluid from the third fluid source 95′″ to circulate through the conduit 96′″ to the heater core 28′″, and/or the valve 322 is open permitting the third fluid from the third fluid source 95′″ to circulate through the conduit 320 to the internal thermal energy exchanger 78′″, and thereby heat the re-circulated air flowing through the first passage 30′″ and/or the second passage 32′″. It is further understood that the valve 306 is open permitting the second fluid to absorb thermal energy from air flowing through the internal thermal energy exchanger 78′″, and thereby heat or charge the phase change material, the coolant, the phase change material coolant, or any combination thereof contained in the second fluid source 302.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A heating, ventilating, and air conditioning (HVAC) system of a vehicle, comprising:
a control module including a housing having an air flow conduit formed therein;
an evaporator core disposed in the air flow conduit, at least a portion of the evaporator core configured to receive a first fluid from a first fluid source therein; and
a thermal energy exchanger disposed in the air flow conduit downstream of the at least a portion the evaporator core and upstream of a blend door disposed in the air flow conduit, wherein the thermal energy exchanger is in thermal energy exchange relationship with an exhaust gas system of the vehicle.

2. The HVAC system of claim 1, wherein the internal thermal energy exchanger is one of another portion of the evaporator core and separate from the evaporator core.

3. The HVAC system of claim 1, wherein the first fluid source is a refrigeration circuit.

4. The HVAC system of claim 1, further comprising a second fluid source in fluid communication with the thermal energy exchanger.

5. The HVAC system of claim 4, wherein the second fluid source is in thermal energy exchange relationship with the exhaust gas system.

6. The HVAC system of claim 4, wherein the second fluid source is one of a fluid reservoir and an external thermal energy exchanger.

7. The HVAC system of claim 4, further comprising a heater core disposed downstream of the thermal energy exchanger, wherein the heater core is in fluid communication with a third fluid source.

8. The HVAC system of claim 7, wherein the thermal energy exchanger is in fluid communication with the third fluid source.

9. The HVAC system of claim 7, further comprising a fourth fluid source in fluid communication with the thermal energy exchanger.

10. The HVAC system of claim 9, wherein the fourth fluid source is in thermal energy exchange relationship with the exhaust gas system of the vehicle.

11. The HVAC system of claim 1, further comprising an external thermal energy exchanger in fluid communication with the thermal energy exchanger.

12. The HVAC system of claim 11, wherein the external thermal energy exchanger is in thermal energy exchange relationship with the exhaust gas system of the vehicle.

13. A heating, ventilating, and air conditioning (HVAC) system of a vehicle, comprising:
a control module including housing having an air flow conduit formed therein;
an evaporator core disposed in the air flow conduit, at least a portion of the evaporator core configured to receive a first fluid from a first fluid source therein;
a thermal energy exchanger disposed in the air flow conduit downstream of the at least a portion the evaporator core and upstream of a blend door disposed in the air flow conduit, the thermal energy exchanger configured to receive a second fluid from a second fluid source therein, wherein the first fluid and the second fluid are different fluid types; and
a heater core disposed downstream of the thermal energy exchanger, wherein the heater core is configured to receive a third fluid from a third fluid source therein, wherein at least one of the thermal energy exchanger and the heater core is in thermal energy exchange relationship with an exhaust gas system of the vehicle.

14. The HVAC system of claim 13, wherein the second fluid source is one of a fluid reservoir and an external thermal energy exchanger in thermal energy exchange relationship with the exhaust gas system.

15. The HVAC system of claim 13, wherein the thermal energy exchanger is in fluid communication with the third fluid source.

16. The HVAC system of claim 13, further comprising a fourth fluid source in fluid communication with the thermal energy exchanger.

17. The HVAC system of claim 16, wherein the fourth fluid source is in thermal energy exchange relationship with the exhaust gas system of the vehicle.

18. The HVAC system of claim 13, further comprising an external thermal energy exchanger in fluid communication with the thermal energy exchanger, wherein the external thermal energy exchanger is in thermal energy exchange relationship with the exhaust gas system of the vehicle.

19. A heating, ventilating, and air conditioning (HVAC) system for a vehicle, comprising:
a control module including housing having an air flow conduit formed therein;
an evaporator core disposed in the air flow conduit, at least a portion of the evaporator core configured to receive a first fluid from a first fluid source therein;
an internal thermal energy exchanger disposed in the air flow conduit downstream of the at least a portion the evaporator core and upstream of a blend door disposed in the air flow conduit, the thermal energy exchanger configured to receive a second fluid from a second fluid source therein, wherein the first fluid and the second fluid are different fluid types;
a heater core disposed downstream of the thermal energy exchanger, wherein the heater core is configured to receive a third fluid from a third fluid source therein; and
an external thermal energy exchanger in fluid communication with at least one of the internal thermal energy exchanger, the second fluid source, and a fourth fluid source, wherein the external thermal energy exchanger is in thermal energy exchange relationship with an exhaust gas system of the vehicle.

20. The HVAC system of claim 19, wherein the fourth fluid source is in thermal energy exchange relationship with the exhaust gas system of the vehicle.
